(19) United States
(12) Patent Application Publication
(10) Pub. No.: US 2010/0063180 A1
(43) Pub. Date: Mar. 11, 2010

(54) FIRE PROTECTION AND/OR FIRE FIGHTING ADDITIVES, ASSOCIATED COMPOSITIONS, AND ASSOCIATED METHODS

(76) Inventors: Seungkoo Kang, Gainesville, FL (US); Detlef Tholmann, Marl (DE)

Correspondence Address: SMITH MOORE LEATHERWOOD LLP, P.O. BOX 21927, GREENSBORO, NC, 27420, US

(21) Appl. No.: 12/205,366

(22) Filed: Sep. 5, 2008

(51) Int. Cl. C08J 3/03; C08L 41/00; A62D 1/00

(52) U.S. Cl. 523/337; 524/547; 169/44; 169/30; 169/91

(57) ABSTRACT

Fire protection and/or fire fighting additives including a water-swellable polymer, a water immiscible phase, an emulsifier, an inverter, and a remainder water are disclosed. The water-swellable polymer is acrylamide-free and crosslinked and may be prepared by inverse phase polymerization. Such fire protection and/or fire fighting additives and fire protection and/or fire fighting compositions made using the additives exhibit exceptionally low corrosion properties. For example, when contacted with any one of a 2024-T3 aluminum alloy, 4130 steel, yellow brass, or AZ31B magnesium alloy, the corrosion rate is less than about 5 mils/yr for the fire protection and/or fire fighting additives.

Aspects of embodiments and embodiments of the present invention relate to a fire protection and/or fire fighting additives, fire protection and/or fire fighting compositions, and associated methods.

### BACKGROUND

Water tends to be the material of choice in fire protection or fire fighting as it is capable of preventing most combustible objects from burning or extinguishing most fires. Water may be supplied from a network of pipes or, in the case of forest fires, for example, from natural sources such as lakes, rivers and streams. Three elements are present for fire (or a chemical chain reaction) to occur and be sustained with combustible objects, namely, fuel, source of ignition (e.g., direct flame, friction—mechanical sparks, electricity, static electricity, lightning, spontaneous heating—decomposition, and the like), and oxidizing agent (e.g., air that is about 21% oxygen, nitrous oxide, oxygen, and the like). Removal of any one of these elements can result in the fire (or the chemical chain reaction) being extinguished. In fire fighting, water may be provided to burning combustible objects to sufficiently cool such objects below their combustion or ignition temperature, and thus may precluded further ignition. In addition, when coming into contact with hot objects, water vaporizes to steam at 212° F. expanding in volume by 1700 times to crowd out the oxidizing agent (e.g., most often air) necessary for combustion.

When spraying water to extinguished burning combustible objects, less than 10% of the sprayed water may be effectively used as there can be water loss due, for example, to run-off, ground absorption, or normal evaporation. This can be frustrating in the case of wildfires (e.g., forest fires, range fires, grass fires, and brushland fires) as the water is often transported a long distance at great cost only to be wasted. Also, wildfires are often preceded by droughts and, accordingly, the ground may be particularly receptive to water absorption.

Ineffective water usage also may be encountered in other situations including, for example, fire protection and/or fire fighting that may be classified as structural fire situations. For example in a case of a building roof fire, water often may flow to lower building stories, for example, from floors through any one of ceilings, openings, ductwork, staircases, and the like thereby being lost to fire protection and/or fire fighting. When water is scarce, the fire may spread from the burning roof downward to the lower building stories. In addition, water flowing to the lower building stories frequently results in considerable water damage.

To improve the action of water in fire protection and/or fire fighting involving wildfire situations, thickened water may be applied to timber and other foliage in the path of a fire to retard advancement of the flame front. Likewise in fire protection and/or fire fighting, fire involving structural fire situations or wildfire situations involving structural fire situations, thickened water may be applied to surfaces of structures, nearby timber, and other foliage to divert the path of a fire away from or around the structure. Various methods of distributing thickened water include direct spraying and aerial dropping. Direct spraying may be advantageous for fire protection in structural fire situations. Aerial dropping may be advantageous in situations or areas that are not easily accessible for spraying. However, improved fire protection and/or fire fighting additives, fire protection and/or fire fighting compositions, and associated methods would be desirable.

### SUMMARY

Aspects of embodiments and embodiments of the present invention meet these and other needs by providing, without limitation, improved fire protection and/or fire fighting additives to result in improved fire protection and/or fire fighting compositions, and associated methods. According to aspects of embodiments and embodiments of the present invention, fire protection and/or fire fighting compositions and associated methods are capable of preventing, retarding, suppressing, and extinguishing fires by applying a sufficient amount of an aqueous composition, including fire protection and/or fire fighting additives to combustible objects, either before or after initiation of combustion.

In aspects of embodiments, a fire protection and/or fire fighting additive includes water-swellable polymer, a water immiscible phase, an emulsifier, an inverter, and a remainder water. The water-swellable polymer is acrylamide-free and crosslinked and may be prepared by inverse phase polymerization, also sometimes referred to as reverse phase polymerization. Also, the water-swellable polymer may be from about 10 wt % to about 70 wt % based on the total weight of the additive. In one aspect the water immiscible phase may be from about 10 wt % to about 80 wt %, based on the total weight of the additive, while in another aspect from about 20 wt % to about 80 wt %, based on the total weight of the additive. The emulsifier may be from about 0.5 wt % to about 10 wt %, based on the total weight of the additive. The inverter may be from about 0.5 wt % to about 10 wt %, based on the total weight of the additive. As noted, water may be the remainder to 100 wt % based on the total weight of the additive.

In aspects of embodiments and/or embodiments, the fire protection and/or fire fighting additive is “free of acrylamide” and/or “acrylamide-free”. It follows that in aspects of embodiments and/or embodiments, the fire protection and/or fire fighting composition is likewise “free of acrylamide” and/or “acrylamide-free”. The term “free of acrylamide and/or acrylamide-free and/or the like” here refers to all fractions of the compound having the CAS No. [79-06-1] and being synonymous with: 2-propenamide; 2-propenamide; acrylamide; acrylic amide; ethylene carboxamide; ethylenecarboxamide; propenamide; propenoic acid, amide; and vinyl amide. Acrylamide comprising compounds such as 2-acrylamido-2-methylpropanesulfonic acid (AMPS), for example, or other acrylamide derivatives are explicitly not covered by this definition. To that end, acrylamide-free water-swellable polymers and water-swellable polymers free of acrylamide according to aspect of embodiments and/or embodiments of the present invention optionally may include acrylamide comprising compounds such as, without limitation, 2-acrylamido-2-methylpropanesulfonic acid (AMPS), for example, or other acrylamide derivatives as any one of a comonomer, copolymer, initiator, crosslinker, . . . the like, or combinations thereof, to the extent that such inclusions do not adversely effect an operation of such aspect of embodiments and/or embodiments of the present invention.

Surprisingly, in an aspect, the fire protection and/or fire fighting additive exhibit exceptionally low corrosion properties. For example, when contacted with any one of a 2024-T3 aluminum alloy, 4130 steel, yellow brass, or AZ31B magnesium alloy, the corrosion rate is less than about 5 mils/yr.

In another aspect, the one or more inverters of the fire protection and/or fire fighting additive are not a nonylphenol ethoxylate. To that end, the one more inverters may be chosen such that the fire protection and/or fire fighting additive, in one aspect, has a swelling time of not more than about 3 minutes, and, in another aspect, not more than about 30 seconds. In yet another aspect, the fire protection and/or fire fighting additive includes from about 0.001 wt % to about 1 wt % of one or more chelators, based on the total weight of the additive.

Other aspects of embodiments relate to a process for making an additive combinable with a fire-extinguishing agent, such as water, for use in a fire protection and/or fire fighting composition. The produced additive may include acrylamide-free, crosslinked, and water-swellable polymer beads dispersed throughout a continuous water immiscible phase. The process includes the steps of forming an aqueous monomer solution, forming aqueous monomer beads, polymerizing the monomer solution to form dispersed water-swellable polymer beads, and adding an inverter and/or a residual-monomer eliminator.

The forming of the aqueous monomer solution involves providing one or more acrylamide-free, water-soluble, and ethylenically unsaturated monomers, one or more neutralizers, and, optionally, one or more ethylenically unsaturated water-soluble sulfonic acid monomers. An amount of one or more acrylamide-free, water-soluble, and ethylenically unsaturated monomers (alternatively stated—an acrylamide-free, water-soluble, and ethylenically unsaturated monomer or an acrylamide-free, water-soluble, and ethylenically unsaturated monomer blend) may be from about 10 wt % to about 60 wt %, based on the total weight of the additive. An amount of one or more ethylenically unsaturated water-soluble sulfonic acid monomers (alternatively stated—an ethylenically unsaturated water-soluble sulfonic acid monomer or an ethylenically unsaturated water-soluble sulfonic acid monomer blend) may be from 0.1 wt % to about 5 wt %, based on the total weight of the additive. An amount of one or more neutralizers (alternatively stated—a neutralizer or a neutralizer blend) may be at least about 25 mol %, based on the total of the monomer or monomer blend. Water may be an amount of remainder of the additive to 100 wt %, based on the total weight of the additive. In an optional aspect, such aqueous monomer solution may include one or more chelators, which in another aspect includes from about 0.001 wt % to about 1 wt %, based on the total weight of the additive.

The forming of aqueous monomer beads from the monomer solution may be done using one or more water-immiscible phases in the presence of one or more emulsifiers. An amount of one or more water-immiscible phases (alternatively stated—water-immiscible phase or water-immiscible phase blend) in one aspect may be from about 10 wt % to about 80 wt %, based on the total weight of the additive, while in another aspect from about 20 wt % to about 80 wt %, based on the total weight of the additive. An amount of one or more emulsifiers (alternatively stated—emulsifier or emulsifier blend) may be from about 0.5 wt % to about 10 wt %, based on the total weight of the additive.

The forming of the polymerizing monomer solution used to form polymer beads may be done in the presence of one or more initiators and one or more crosslinkers. An amount of the one or more initiators (alternatively stated—initiator or initiator blend) may be from about 0.1 wt % to about 5 wt % of one or more thermal initiators, based on the total weight of the additive. An amount of the one or more crosslinkers (alternatively stated—crosslinker or crosslinker blend) may be about 0.01 wt % to about 2 wt %, based on the total weight of the additive.

In an aspect, one or more inverters and, optionally, one or more residual-monomer eliminators may be added. Such one or more inverters are not a nonylphenol ethoxylate. An amount of the one or more inverters (alternatively stated—inverter or inverter blend) may be from about 0.5 wt % to about 10 wt %, based on the total weight of the additive. When used, an amount of the one or more a residual-monomer eliminators (alternatively stated—residual-monomer eliminator or residual-monomer eliminator blend) may be from about 0.1 wt % to about 2 wt %, based on the total weight of the additive.

Surprisingly, in an aspect, the fire protection and/or fire fighting additive exhibit exceptionally low corrosion properties. For example, one aspect when contacted with any one of a 2024-T3 aluminum alloy, 4130 steel, yellow brass, or AZ31B magnesium alloy, the corrosion rate is less than about 5 mils/yr. Even more surprising, in another aspect, when contacted with any one of a 2024-T3 aluminum alloy, 4130 steel, or yellow brass, the corrosion rate is less than about 1 mil/yr.

In still other aspects of embodiments, a fire protection and/or fire fighting composition includes (e.g., is made using) a fire protection and/or fire fighting additive and one or more fire-extinguishing agents. An amount of the fire protection and/or fire fighting additive may be from about 0.1 wt % to about 5 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase, based on the total weight of the additive, while in another aspect from about 20 wt % to about 80 wt % of water immiscible phase, based on the total weight of the additive, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

In an aspect, the viscosity of the fire protection and/or fire fighting composition is such that the composition is flowable when subjected to the shear forces of any type of conventional fire fighting equipment while at the same time remain on a surface (e.g., such as any one of a vertical surface, sloped surface, projecting surface, a horizontal surface, or any combinations thereof) for a prevention of fire and/or to combat fire. Such conventional equipment is described, for example, in the U.S. Pat. No. 5,989,446 (EP0774279B1) and in the German patent DE 299 04 848 U1. To that end, according to one aspect, the fire protection and/or fire fighting composition is formulated to attain a viscosity of at least about 100 mPa·s. According to another aspect, the fire protection and/or fire fighting composition is formulated to attain over about 1,000 mPa·s, measured according to Brookfield (1 Revolutions Per Minute {abbreviated rpm, RPM, r/min, or r·min-1} at about 70° C. {about 21° C.}), and according to another aspect to between about 5,000 and about 50,000 mPa·s.

Surprisingly, in an aspect, the fire protection and/or fire fighting composition exhibit exceptionally low corrosion properties. For example, in one aspect, when contacted with any one of a 4130 steel or yellow brass, the corrosion rate is less than about 5 mils/yr while when contacted with AZ31B magnesium alloy, the corrosion rate is less than about 4 mils/yr. Even more surprising, in another aspect, when contacted with any one of a 4130 steel, or yellow brass, the corrosion rate is less than about 1 mil/yr., while when contacted with 2024-T3 aluminum, the corrosion rate is less than about 2 mils/yr.

In yet still other aspects of embodiments, a sufficient amount of a fire protection and/or fire fighting composition is applied to a combustible object to prevent, retard, suppress, or extinguish a fire. The fire protection and/or fire fighting composition includes (e.g., is made using) a fire protection and/or fire fighting additive and one or more fire-extinguishing agents. An amount of the fire protection and/or fire fighting additive may be from about 0.1 wt % to about 5 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase while in another aspect from about 20 wt % to about 80 wt % of water immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

In still other aspects of embodiments, a device for the prevention and/or fighting of fires includes a pressure-resistant container in which a fire protection and/or fire fighting additive and fire-extinguishing agent are present and separated from one another. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase while in another aspect from about 20 wt % to about 80 wt % of water immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive. To that end in an embodiment, the device may be a manual fire-extinguisher or a fire-extinguisher train.

In still yet other aspects of embodiments, a device for the prevention and/or fighting of fires includes a pressure-resistant container in which a fire protection and/or fire fighting additive and fire-extinguishing agent are present and combined with one another as a fire protection and/or fire fighting composition. The fire protection and/or fire fighting composition may be from about 0.1 wt % to about 5 wt % of a fire protection and/or fire fighting additive, based on the total weight of the composition, and from about 95 wt % to about 99.9 wt % of a fire-extinguishing agent, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase while in another aspect from about 20 wt % to about 80 wt % of water immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive. To that end in an embodiment, the device may be a manual fire-extinguisher or a fire-extinguisher train.

Accordingly, aspects of embodiments and embodiments of the present invention are directed to a fire protection and/or fire fighting additive including water-swellable polymer, a water immiscible phase, an emulsifier, an inverter, and a remainder water. The water-swellable polymer is acrylamide-free and crosslinked and may be prepare by inverse phase polymerization, also sometimes referred to as reverse phase polymerization. Also, the water-swellable polymer may be from about 10 wt % to about 70 wt % based on the total weight of the additive. The water immiscible phase may be in one aspect from about 10 wt % to about 80 wt %, based on the total weight of the additive, while in another aspect from about 20 wt % to about 80 wt %, based on the total weight of the additive. The emulsifier may be from about 0.5 wt % to about 10 wt %, based on the total weight of the additive. The inverter may be from about 0.5 wt % to about 10 wt %, based on the total weight of the additive. As noted, water may be the remainder to 100 wt % based on the total weight of the additive. The fire protection and/or fire fighting additive is acrylamide free in that it does not include acrylamide.

Other aspects of embodiments and embodiments of the present invention are directed to a process for making an additive combinable with water for use in a fire protection and/or fire fighting composition. The produced additive may include acrylamide-free, crosslinked, and water-swellable polymer beads dispersed throughout a continuous water immiscible phase. The process includes the steps of forming an aqueous monomer solution, forming aqueous monomer beads, polymerizing the monomer solution to form dispersed water-swellable polymer beads, and adding an inverter and/or a residual-monomer eliminator.

The forming of the aqueous monomer solution involves providing one or more of an acrylamide-free, water-soluble, and ethylenically unsaturated monomers, one or more neutralizers, and, optionally, one or more an ethylenically unsaturated water-soluble sulfonic acid monomers. An amount of one or more acrylamide-free, water-soluble, and ethylenically unsaturated monomers (alternatively stated—an acrylamide-free, water-soluble, and ethylenically unsaturated monomer or an acrylamide-free, water-soluble, and ethylenically unsaturated monomer blend) may be from about 10 wt % to about 60 wt %, based on the total weight of the additive. An amount of one or more ethylenically unsaturated water-soluble sulfonic acid monomers (alternatively stated—an ethylenically unsaturated water-soluble sulfonic acid monomer or an ethylenically unsaturated water-soluble sulfonic acid monomer blend) may be from 0.1 wt % to about 5 wt %, based on the total weight of the additive. An amount of one or more neutralizers (alternatively stated—a neutralizer or a neutralizer blend) may be at least about 25 mol %, based on the total of the monomer or monomer blend. Water may be an amount of remainder of the additive to 100 wt %, based on the total weight of the additive.

The forming of the monomer solution may be done using one or more water-immiscible phases in the presence of one or more emulsifiers. An amount of one or more water-immiscible phases (alternatively stated—water-immiscible phase or water-immiscible phase blend) may be in one aspect from about 10 wt % to about 80 wt %, based on the total weight of the additive, while in another aspect from about 20 wt % to about 80 wt %, based on the total weight of the additive. An amount of one or more emulsifiers (alternatively stated—emulsifier or emulsifier blend) may be from about 0.5 wt % to about 10 wt %, based on the total weight of the additive.

The forming of the polymerizing of the monomer solution to form polymer beads may be done in the presence of one or more initiators and one or more crosslinkers. An amount of the one or more initiators (alternatively stated—initiator or initiator blend) may be from about 0.1 wt % to about 5 wt % of one or more initiators thermal initiators, based on the total weight of the additive. An amount of the one or more crosslinkers (alternatively stated—crosslinker or crosslinker blend) may be about 0.01 wt % to about 2 wt %, based on the total weight of the additive.

In an aspect, one or more inverters and, optionally, one or more residual-monomer eliminators may be added. An amount of the one or more inverters (alternatively stated—inverter or inverter blend) may be from about 0.5 wt % to about 10 wt %, based on the total weight of the additive. When used, an amount of the one or more a residual-monomer eliminators (alternatively stated—residual-monomer eliminator or residual-monomer eliminator blend) may be from about 0.1 wt % to about 2 wt %, based on the total weight of the additive.

Still other aspects of embodiments and embodiments of the present invention are directed to a fire protection and/or fire fighting composition including (e.g., made using) a fire protection and/or fire fighting additive and one or more fire-extinguishing agents. An amount of the fire protection and/or fire fighting additive may be from about 0.1 wt % to about 5 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of a water-immiscible phase while in another aspect from about 20 wt % to about 80 wt % of a water-immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

Still yet other aspects of embodiments and embodiments of the present invention are directed to a method of applying a sufficient amount of a fire protection and/or fire fighting composition to the combustible object to prevent, retard, suppress, or extinguish a fire. The fire protection and/or fire fighting composition includes (e.g., is made using) a fire protection and/or fire fighting additive and one or more fire-extinguishing agents. An amount of the fire protection and/or fire fighting additive may be from about 0.1 wt % to about 5 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of a water-immiscible phase while in another aspect about 20 wt % to about 80 wt % of a water-immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

Still yet other aspects of embodiments and embodiments of the present invention are directed to a device for the prevention and/or fighting of fires including a pressure-resistant container in which a fire protection and/or fire fighting additive and fire-extinguishing agent are present and separated from one another. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of a water-immiscible phase while in another aspect from about 20 wt % to about 80 wt % of a water-immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

In still yet other aspects of embodiments, a device for the prevention and/or fighting of fires includes a pressure-resistant container in which a fire protection and/or fire fighting additive and fire-extinguishing agent are present and combined with one another as a fire protection and/or fire fighting composition. The fire protection and/or fire fighting composition may be from about 0.1 wt % to about 5 wt % of a fire protection and/or fire fighting additive, based on the total weight of the composition, and from about 95 wt % to about 99.9 wt % of a fire-extinguishing agent, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase while in another aspect from about 20 wt % to about 80 wt % of water immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive. To that end in an embodiment, the device may be a manual fire-extinguisher or a fire-extinguisher train.

Numerous other aspects of embodiments, embodiments, features, and advantages of the present invention will appear from the following detailed description and the accompanying drawings. In the description and/or the accompanying drawings, reference is made to exemplary aspects of embodiments and/or embodiments of the invention which can be applied individually or combined in any way with each other. Such aspects of embodiments and/or embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Also in the interest of brevity and conciseness, it is to be understood that such terms as “is,” “are,” “includes,” “having,” “comprises,” and the like are words of convenience and are not to be construed as limiting terms and yet may encompass the terms “comprises,” “consists essentially of,” “consists of,” and the like as is appropriate.

These and other aspects, advantages, and salient features of the present invention will become apparent from the following detailed description, the accompanying drawings, and the appended claims.

### DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

### I. ACRYLAMIDE-FREE, FIRE PROTECTION AND/OR FIRE FIGHTING ADDITIVE

As noted, aspects of embodiments and embodiment of the present invention relate to a fire protection and/or fire fighting additive. Such fire protection and/or fire fighting additive includes water-swellable polymer, a water immiscible phase, an emulsifier, an inverter, and a remainder water. The water-swellable polymer is acrylamide-free and crosslinked and may be prepared by inverse phase polymerization, also sometimes referred to as reverse phase polymerization. Also, in one aspect, the water-swellable polymer may be from about 10 wt % to about 70 wt %; in another aspect, the water-swellable polymer may be from about 20 wt % to about 50 wt %; and in yet another aspect, the water-swellable polymer may be from about 25 wt % to about 35 wt %, each based on the total weight of the additive. Further, in one aspect, the water immiscible phase may be from about 10 wt % to about 80 wt %; in another aspect, the water immiscible phase may be from about 20 wt % to about 80 wt %; in still another aspect, the water immiscible phase may be from about 25 wt % to about 75 wt %; and in still yet another aspect the water immiscible phase may be from about 30 wt % to about 65 wt %, each based on the total weight of the additive. Furthermore, in one aspect, the emulsifier may be from about 0.5 wt % to about 10 wt %; in another aspect, the emulsifier may be from about 0.7 wt % to about 7 wt %; and in still another aspect, the emulsifier may be from about 0.9 wt % to about 6 wt %, each based on the total weight of the additive. Moreover, in one aspect, the inverter may be from about 0.5 wt % to about 10 wt %; in another aspect, the inverter may be from about 0.7 wt % to about 7 wt %; and in still another aspect, the inverter may be from about 0.9 wt % to about 6 wt %, each based on the total weight of the additive. As noted, water may be the remainder to 100 wt % based on the total weight of the additive. The fire protection and/or fire fighting additive is acrylamide free in that it does not include acrylamide.

A. Acrylamide-Free, Ethylenically Unsaturated, and Water-Soluble or Water-Dispersible Monomer or Acrylamide-Free, Ethylenically Unsaturated, and Water-Soluble or Water-Dispersible Monomer Blend

Aspects of embodiments and embodiments of the present invention relate to fire protection and/or fire fighting additives and one or more ethylenically unsaturated and acrylamide-free monomers. Suitable acrylamide-free monomers include, but are not limited to, ethylenically unsaturated, acidic group-containing monomers or salts thereof, or polymerized, ethylenically unsaturated monomers containing a protonated, or a quaternary nitrogen, or mixtures thereof.

In aspects of an embodiment, monoethylenically unsaturated, acidic group-containing monomers (α1) include, but are not limited to, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbinic acid, α-chlorosorbinic acid, 2′-methylisocrotonic acid, cinnamic acid, p-chlorocinnamic acid, β-stearic acid, itaconic acid, citraconic acid, mesaconic acid, glutaconic acid, aconitic acid, maleic acid, fumaric acid, maleic acid anhydride, or mixtures thereof.

In aspects of another embodiment, ethylenically unsaturated monomers (α1) containing a protonated nitrogen include, but are not limited to, dialkylaminoethyl(meth)acrylate-hydrochlorides in the protonated form, for example dimethylaminoethyl(meth)acrylate-hydrochloride dimethylaminoethyl(meth)acrylate-hydrosulfate, or mixtures thereof, as well as dialkylaminoalkyl(meth)acrylamides in the protonated form, for example dimethylaminoethyl(meth)acrylamide-hydrochloride, dimethylaminopropyl(meth)acrylamide-hydrochloride, dimethylaminopropyl(meth)acrylamide-hydrosulfate, and dimethylaminoethyl(meth)acrylamide-hydrosulfate.

In aspects of yet another embodiment, ethylenically unsaturated monomers (α1) containing a quaternated nitrogen include, but are not limited to, dialkylammoniumalkyl(meth)acrylates in quaternated form, for example trimethylammoniumethyl(meth)acrylate-methosulfate or dimethylethylammoniumethyl(meth)acrylate-ethosulfate, (meth)acrylamidoalkyldialkylamines in quaternated form, for example (meth)acrylamidopropyltrimethylammonium chloride, trimethylammoniumethyl(meth)acrylate chloride, or (meth)acrylamidopropyltrimethylammonium sulfate, or mixtures thereof.

According to one aspect of yet another embodiment of the invention, the polymer may comprise at least about 50 wt %, in another aspect at least about 70 wt %, and in yet another aspect at least about 90 wt % carboxylate group-containing monomers. According to one aspect of still yet another embodiment of the invention, the polymer may comprise at least about 50 wt % and in another aspect at least about 70 wt % acrylic acid, which in one aspect may be neutralized to at least about 20 mol % and in another aspect to at least about 50 mol %.

In further aspects of embodiments, monoethylenically unsaturated monomers (α2) may be copolymerized with monoethylenically unsaturated, acidic group-containing monomers (α1) including, but are not limited to, water dispersible monomers. In aspects of embodiments, the water dispersible monomers include, but are not limited to, acrylic acid esters and methacrylic acid esters, such as methyl(meth)acrylate, ethyl(meth)acrylate, propyl(meth)acrylate, butyl(meth)acrylate, vinylacetate, styrene, isobutylene, or mixtures thereof.

As noted, aspects of embodiments and embodiments of the present invention relate to fire protection and/or fire fighting additives and one or more ethylenically unsaturated and acrylamide-free monomers. To that end, such ethylenically unsaturated and acrylamide-free monomers are free of acrylamides and (meth)acrylamides. Further, such ethylenically unsaturated and acrylamide-free monomers, besides acrylamide and methacrylamide, are free of (meth)acrylamides such as alkyl-substituted (meth)acrylamides or amino alkylsubstituted derivatives of (meth)acrylamides such as N-methylol(meth)acrylamide, N,N-dimethylamino(meth)acrylamide, dimethyl(meth)acrylamide, or diethyl(meth)acrylamide. Moreover, such ethylenically unsaturated and acrylamide-free monomers, besides acrylamide and methacrylamide, are free of vinylamides such as N-vinylamides, N-vinylformamides, N-vinylacetamides, N-vinyl-N-methylacetamide, N-vinyl-N-methylformamides, and vinylpyrrolidone.

B. Neutralizer or Neutralizer Blend

Some aspects of embodiments of the present invention relate to the monoethylenically unsaturated, acidic group-containing monomers (α1) being partially neutralized or fully neutralized. In an aspect, the monoethylenically unsaturated acidic groups are neutralized to at least about 25 mol %, in another aspect at least about 50 mol %, and in yet another aspect to about 50 to about 90 mol %. The neutralization of the monoethylenically unsaturated, acidic group-containing monomers (α1) can occur before polymerization, during polymerization, after polymerization, or combinations thereof. Neutralizers include, but are not limited to, alkali metal hydroxides, alkaline earth metal hydroxides, ammonia, carbonates, or bicarbonates. In addition, any further base which forms a water-soluble salt with the acid is conceivable. Neutralizer mixtures or neutralizer blends with different bases is also conceivable. Some examples of neutralizer include, but are not limited to, ammonia or with alkali metal hydroxides such as sodium hydroxide or potassium hydroxide.

C. Ethylenically Unsaturated, Water-Soluble or Water-Dispersible Sulfonic Acid Monomer or Ethylenically Unsaturated, Water-Soluble or Water-Dispersible Sulfonic Acid Blend

Besides carboxylate group-containing monomers, some aspects of embodiments and embodiments of the present invention relate to fire protection and/or fire fighting additives further including ethylenically unsaturated sulfonic acid monomers or ethylenically unsaturated phosphonic acid monomers.

In aspects of an embodiment, ethylenically unsaturated sulfonic acid monomers include, but are not limited to, allylsulfonic acid or aliphatic or aromatic vinylsulfonic acids or acrylic or methacrylic sulfonic acids such as vinylsulfonic acid, 4-vinylbenzylsulfonic acid, vinyltoluenesulfonic acid, and styrenesulfonic acid. In aspects of another embodiment, acrylic or methylacrylic sulfonic acids include, but are not limited to, sulfoethyl(meth)acrylate, sulfopropyl(meth)acrylate, and 2-hydroxy-3-methacryloxypropylsulfonic acid. In aspects of yet another embodiment, acrylic or methylacrylic sulfonic acids include, but are not limited to, (meth)acrylamidoalkylsulfonic acid, 2-acrylamido-2-methylpropansulfonic acid, or mixtures thereof.

In aspects of another embodiment, ethylenically unsaturated phosphonic acid monomers include, but are not limited to, vinylphosphonic acid, allylphosphonic acid, vinylbenzylphosphonic acid, (meth)acrylamidoalkylphosphonic acids, acrylamidoalkyldiphosphonic acids, phosphonomethylated vinylamines, (meth)acrylphosphonic acid derivatives, or mixtures thereof.

D. Water-Immiscible Phase

Some aspects of embodiments of the present invention relate to the water-immiscible phase of the fire protection and/or fire fighting additive. In an aspect, the water-immiscible phase of the additive includes one or more natural oils of vegetable origin or animal origin. Such natural oils may be denatured or refined products. Main components of the natural oils are primarily triglycerides whose carboxylic acid moiety is derived from monoethylenically or polyethylenically unsaturated and from saturated C10-C30-fatty acids. Examples of suitable vegetable oils include, without limitation, avocado oil, castor oil, canola oil, Chinese wood oil, coffee oil, cotton seed or cotton oil, corn oil, germ oil, Japanese wood oil, jojoba oil, kaya oil, linseed oil, macadamia nut oil, olive oil, peanut oil, perilla oil, persic oil, rapeseed oil, rice bran oil, sesame seed oil, safflower oil, sasanqua oil, sunflower oil, soybean oil, tea seed oil, tsubaki oil, wheat germ oil, triglycerol, glyceryl trioctanoate, glyceryl triisopalmitate, or mixtures thereof. Examples of suitable animal oils include, without limitation, fish oils, for example, herring oil, salmon oil, sardine oil, shark liver oil, whale oil, or mixtures thereof. In addition to the fish oils, other examples of suitable animal oils include, without limitation, bone oil, egg yolk oil, lard oil, mink oil, neatsfoot oil, tallow oil, turtle oil, mixtures thereof, or mixtures thereof with one or more fish oils. Both the pure oils and mixtures of any oils may form the water-immiscible phase of the fire protection and/or fire fighting additive. In an aspect, the water-immiscible phase is one of sunflower oil, rapeseed oil, whale oil, tallow oil, or combinations thereof.

In another aspect, the natural oils of vegetable origin or animal origin may be used with virtually any water-immiscible liquids employed to date for the preparation of water-in-oil polymer emulsions. Suitable components for use alone or mixing with the natural oils include virtually any water-immiscible liquids that are biodegradable, for example the aliphatic dicarboxylic esters disclosed in U.S. Pat. No. 4,824,894 (DE-B-3 524 950). Suitable components for use alone or mixing with the natural oils include oil components typically blended in cosmetics such as liquid fats/oils, solid fats/oils, waxes, hydrocarbons, higher fatty acids, higher alcohols, synthetic esters, and silicones. Other suitable components for use alone or mixing with the naturally oils include selected oleophilic monocarboxylic add esters, polycarboxylic acid esters, at least substantially water-insoluble alcohols which flow freely under working conditions, corresponding ethers and selected carbonic and esters, cf. U.S. Pat. No. 5,232,910 (EP0374671), U.S. Pat. No. 5,252,554 (EP0374672), EP0386638, EP0386636, EP0382070, EP0382071, EP0391252, EP0391251, EP0532570, EP0535074. Still other suitable components for use alone or mixing with the natural oils include classes of compounds that have been proposed as a replacement for mineral oils in water in oil (w/o) invert muds, such as, acetals, α-olefins (LAO), poly-α-olefins (PAO), internal olefins (IO), (oligo)amides, (oligo)imides and (oligo)ketones, cf. EP 0 512 501, EP 0 627 481, GB 2,258,258, U.S. Pat. No. 5,068,041, U.S. Pat. No. 5,189,012, WO 95130643, and WO 95132260.

E. Emulsifier or Emulsifier Blend

Some aspects of embodiments of the present invention relate to the one or more emulsifies of the fire protection and/or fire fighting additive. In an aspect, the one or more emulsifiers may be selected from one or more surfactants. Suitable surfactants include, but are not limited to, natural surfactants (e.g., surfactants based on natural components such as fatty acids, coconut oil, . . . etc.), anionic surfactants, cationic surfactants, nonionic surfactants, amphoteric surfactants, or combinations thereof. Natural surfactants include, but are not limited to, coconut-based soap solutions. Anionic surfactants include, but are not limited to, dodecyl benzene sulfonic acid and its salts, alkyl ether sulfates and salts thereof, olefin sulfonates, phosphate esters, soaps, sulfosuccinates, and alkylaryl sulfonates. Cationic surfactants include, but are not limited to, alkoxylated cationic ammonium surfactants. Nonionic surfactants include, but are not limited to, alkoxylates of alkyl phenols and alcohols, alkanolamides, and alkyl polyglycocides. Amphoteric surfactants include, but are not limited to, imidazoline derivatives, betaines, and amine oxides. In a particular aspect, the one or more emulsifiers include, without limitation, sorbitan esters, phthalic acid esters, fatty acid glycerides, ethoxylated derivatives of the same, or combinations thereof. Quite particularly, in other aspects polymeric emulsifiers with the trade name Hypermer® (from Croda International Plc) may be used.

F. Initiator or Initiator Blend

Some aspects of embodiments of the present invention relate to the presence of one or more initiators to polymerize a monomer solution used to form polymer beads. Such one or more initiators may be any one of soluble in an aqueous phase, dispersible in an aqueous phase, soluble in a water-insoluble phase, dispersible in a water-insoluble phase, or combinations of any of the preceding. In one aspect, an amount of the one or more initiators may be from about 0.001 wt % to about 8 wt % of one or more thermal initiators; in another aspect the one or more initiators may be from about 0.01 wt % to about 6 wt % of one or more thermal initiators; and in yet another aspect the one or more initiators may be from about 0.1 wt % to about 5 wt % of one or more thermal initiators, each based on the total weight of the additive.

Surprisingly, it was found that to polymerization of the one or more acrylamide-free, water-soluble, and ethylenically unsaturated monomers and the one or more ethylenically unsaturated water-soluble sulfonic acid monomer in a manner to create a fire protection and/or fire fighting additive suitable for use as a fire protection and/or fire fighting chemical, one or more thermal initiators are included in the presence of the polymerization process. Useful thermal initiators include persulfates (e.g., ammonium or alkali metal {potassium, sodium or lithium} persulfate), peroxides (e.g., tert-butyl hydroperoxide {TBHP}), “azo” compounds (i.e., compounds which contain the —N═N-structure). Any of the azo compounds having some solubility and/or dispersibility in any one of water, an aqueous phase, a water-insoluble phase, mixture thereof, of any combination thereof and that have an about 10 hour half life at 30° C. or above may be used. Any persulfates and/or peroxides and/or azo compounds having some solubility and/or dispersibility in any one of water, an aqueous phase, a water-insoluble phase, mixture thereof, of any combination thereof and that have an about 10 hour half life at 30° C. or above may be used. Examples of thermal initiators include but are not limited to:
ammonium persulfate (APS, {NH₄}₂S₂O₈);
lithium persulfate (LPS, Li₂S₂O₈)
potassium persulfate (KPS, K₂S₂O₈)
sodium persulfate (SPS or NaPS, Na₂S₂O₈)
2,2′-azobis(isobutyronitrile);
azobisisobutyronitrile (AIBN);
4,4′-butylazo-cyanovaleric acid;
4-t-butylazo-4′-cyanovaleric acid;
4,4′-azobis(cyanovaleric acid),
4,4′-azobis(4-cyanovaleric acid);
2,2′-azobis(amidinopropane)dihydrochloride;
2,2′-azobis(2-amidinopropane)dihydrochloride (ABAP);
2,2′-azobis(2,4-dimethylvaleronitrile);
dimethyl 2,2′-azobis-isobutyrate;
2,2′-azodimethyl bis(2,4-dimethyl-valeronitrile);
(1-phenylethyl)azodiphenylmethane; 2,2′-azobis(2-methylbutyronitrile);
1,1′-azobis(1-cyclohexanecarbonitrile); 2-(carbamoylazo)-isobutyronitrile;
2,2′-azobis(2,4,4-trimethylpenta-2-phenylazo-2,4-dimethyl-4-methoxyvaleronitrile;
2,2′-azobis(2-methylpropane);
2,2′-azobis(N,N′dimethyleneisobutyramidine)dihydrochloride;
4,4′-azobis(4-cyanopentanoic acid);
2,2′-azobis(2-methyl-N-[1,1-bis(hydroxymethyl)-2-hydroxyethyl]propionamide);
2,2′-azobis(2-methyl-N-[1,1-bis(hydroxymethyl)ethyl]propionamide);
2,2′-azobis[2-methyl-N(2-hydroxyethyl)propionamide];
2,2′-azobis(isobutyramide)dehydrate;
   other thermal initiators known to persons skilled in the art; or any combination thereof.

In aspects any one of 2,2′-azobis[2-(2-imidazolin-2-yl)propane]dihydrochloride, commercially available under the tradename VA-044;
2,2′-azobis[2-(2-imidazolin-2-yl)propane]disulfate dehydrate, commercially available under the tradename VA-046B;
2,2′-azobis[N-(2-carboxyethyl)-2-methylpropionamidine]hydrate, commercially available under the tradename VA-046B; 2,2′-azobis(2-amidinopropane)dihydrochloride, commercially available under the tradename VA-057;
2,2′-azobis {2-[1-(2-hydroxyethyl)-2-imidazolin-2-yl]propane}dihydrochloride, commercially available under the tradename VA-060;
2,2′-azobis[2-(2-imidazolin-2-yl)propane], commercially available under the tradename VA-061; 2,2′-azobis(1-imino-1-pyrrolidino-2-ethylpropane)dihydrochloride], commercially available under the tradename VA-067;
2,2′-azobis{2-methyl-N-[1,1-bis(hydroxymethyl)-2-hydroxyethyl]propionamide}], commercially available under the tradename VA-080;
2,2′-Azobis[2-methyl-N-(2-hydroxyethyl)propionamide]}], commercially available under the tradename VA-086; or combinations thereof (all available from Wako Chemicals U.S.A., Inc., Richmond, Va., may be used as the thermal initiator. The one or more initiators typically are used in an aqueous solution, but the one or more initiators may be diluted with another suitable solvent including, without limitation, a water-insoluble phase.

G. Crosslinker or Crosslinker Blend

Some aspects of embodiments of the present invention relate to the presence of one or more crosslinkers while and/or or following a polymerization of a monomer solution used to form polymer beads. Such one or more crosslinkers may be any one of soluble in an aqueous phase, dispersible in an aqueous phase, soluble in a water-insoluble phase, dispersible in a water-insoluble phase, or combinations of any of the preceding. In one aspect, an amount of the one or more initiators (alternatively stated—crosslinker or crosslinker blend) may be from about 0.005 wt % to about 5 wt % of one or more crosslinkers; in another aspect the one or more initiators may be from about 0.008 wt % to about 3 wt % of one or more crosslinkers; and in yet another aspect the one or more initiators may be from about 0.01 wt % to about 2 wt % of one or more crosslinkers, each based on the total weight of the additive.

In an aspect, crosslinkers (α3) include any one of: compounds that have at least two ethylenically unsaturated groups in one molecule (crosslinker class I); compounds that have at least two functional groups that can react with functional groups of the monoethylenically unsaturated, acidic group-containing monomers (α1) or monomers (α2) in a condensation reaction (=condensation crosslinkers), an addition reaction or a ring-opening reaction (crosslinker class II); compounds that have at least one ethylenically unsaturated group and at least one functional group that can react with functional groups of the monoethylenically unsaturated, acidic group-containing monomers (α1) or monomers (α2) in a condensation reaction, an addition reaction or a ring-opening reaction (crosslinker class III); or polyvalent metal cations (crosslinker class (IV). To that end, a cross-linking of the polymer may be achieved with the compounds of crosslinker class I by radical polymerization of the ethylenically unsaturated groups of the crosslinker molecules with the monoethylenically unsaturated monomers (α1) or (α2), while with the compounds of crosslinker class II and the polyvalent metal cations of crosslinker class IV a cross-linking of the polymer may be achieved via condensation reaction of the functional groups (crosslinker class II) or via electrostatic interaction of the polyvalent metal cation (crosslinker class IV) with the functional groups of the monoethylenically unsaturated, acidic group-containing monomers (α1) or monomer (α2). With compounds of crosslinker class III a cross-linking of the polymers may be achieved correspondingly by radical polymerization of the ethylenically unsaturated groups or just as well by condensation reaction between the functional groups of the crosslinkers and the functional groups of the monoethylenically unsaturated, acidic group-containing monomers (α1) or monomers (α2).

Examples of compounds of crosslinker class I include poly(meth)acrylic acid esters, which have been obtained for example by conversion of a polyol, such as for example ethylene glycol, propylene glycol, trimethylolpropane, 1,6-hexanediol, glycerin, pentaerythritol, polyethyleneglycol or polypropyleneglycol, of an aminoalcohol, a polyalkylenepolyamine, such as for example diethylenetriamine or triethylenetetraamine, or of an alkoxidized polyol with acrylic acid or methacrylic acid. In further aspects compounds of crosslinker class I may be polyvinyl compounds, poly(meth)allyl compounds, (meth)acrylic acid esters of a monovinyl compound or (meth)acrylic acid esters of a mono(meth)allyl compound, in an aspect of the mono(meth)allyl compounds of a polyol or of an aminoalcohol. In this context, reference is made to DE 195 43 366 and DE 195 43 368.

Examples of crosslinker class I compounds, named alkenyldi(meth)acrylates, include: ethyleneglycoldi(meth)acrylate, 1,3-propyleneglycoldi(meth)acrylate, 1,4-butyleneglycoldi(meth)acrylate, 1,3-butyleneglycoldi(meth)acrylate, 1,6-hexanedioldi(meth)acrylate, 1,10-decanedioldi(meth)acrylate, 1,12-dodecanedioldi(meth)acrylate, 1,18-octadecanedioldi(meth)acrylate, cyclopentanedioldi(meth)acrylate, neopentylglycoldi(meth)acrylate, methylenedi(meth)acrylate or pentaerythritoldi(meth)acrylate, alkenyldi(meth)acrylamides, for example N-methyldi(meth)acrylamide, N,N′-3-methylbutylidenebis(meth)acrylamide, N,N′-(1,2-dihydroxyethylene)bis(meth)acrylamide, N,N′-hexamethylenebis(meth)acrylamide or N,N′-methylenebis(meth)acrylamide, polyalkoxydi(meth)acrylates, for example diethyleneglycoldi(meth)acrylate, triethyleneglycoldi(meth)acrylate, tetraethyleneglycoldi(meth)acrylate, dipropyleneglycoldi(meth)acrylate, tripropyleneglycoldi(meth)acrylate or tetrapropyleneglycoldi(meth)acrylate, bisphenol-A-di(meth)acrylate, ethoxylated bisphenol-A-di(meth)acrylate, benzylidenedi(meth)acrylate, 1,3-di(meth)acryloyloxypropanol-2, hydroquinonedi(meth)acrylate, di(meth)acrylate esters of trimethylolpropane, which are in an aspect alkoxylated with 1 to 30 mol alkylene oxide per hydroxyl group, in another aspect ethoxylated, thioethyleneglycoldi(meth)acrylate, thiopropyleneglycoldi(meth)acrylate, thiopolyethyleneglycoldi(meth)acrylate, thiopolypropyleneglycoldi(meth)acrylate, divinyl ethers, for example, 1,4-butanedioldivinylether, divinyl esters, for example divinyladipate, alkanedienes, for example, butadiene or 1,6-hexadiene, divinylbenzene, di(meth)allyl compounds, for example, di(meth)allylphthalate or di(meth)allylsuccinate, homo- and co-polymers of di(meth)allyldimethylammonium chloride and homo- and co-polymers of diethyl(meth)allylaminomethyl(meth)acrylateammonium chloride, vinyl(meth)acrylic compounds, for example, vinyl(meth)acrylate, (meth)allyl(meth)acrylic compounds, for example, (meth)allyl(meth)acrylate, (meth)allyl(meth)acrylate ethoxylated with 1 to 30 mol ethylene oxide per hydroxyl group, di(meth)allylesters of polycarbonic acids, for example, di(meth)allylmaleate, di(meth)allylfumarate, di(meth)allylsuccinate or di(meth)allylterephthalate, compounds with 3 or more ethylenically unsaturated, radically polymerizable groups such as, for example, glycerine tri(meth)acrylate, (meth)acrylate esters of glycerins ethoxylated with in an aspect 1 to 30 mol ethylene oxide per hydroxyl group, trimethylolpropanetri(meth)acrylate, tri(meth)acrylate esters of trimethylolpropane which is alkoxylated in an aspect with 1 to 30 mol alkylene oxide per hydroxide group, in an aspect ethoxylated, trimethacrylamide, (meth)allylidenedi(meth)acrylate, 3-allyloxy-1,2-propanedioldi(meth)acrylate, tri(meth)allylcyanurate, tri(meth)allylisocyanurate, pentaerythritoltetra(meth)acrylate, pentaerythritoltri(meth)acrylate, (meth)acrylic acid esters of pentaerythritol which is ethoxylated with in an aspect 1 to 30 mol ethylene oxide per hydroxyl group, tris(2-hydroxyethyl)isocyanuratetri(meth)acrylate, trivinyltrimellitate, tri(meth)allylamine, di(meth)allylalkylamines, for example di(meth)allylmethylamine, tri(meth)allylphosphate, tetra(meth)allylethylenediamine, poly(meth)allyl ester, tetra(meth)allyloxyethane or tetra(meth)allylammonium halides.

Examples of compounds of crosslinker class II include compounds which have at least two functional groups which can react with the functional groups of the monoethylenically unsaturated, acidic group-containing monomers (α1) or monomers (α2), in an aspect with acidic groups of the monoethylenically unsaturated, acidic group-containing monomers (α1), in a condensation reaction (=condensation crosslinkers), in an addition reaction or in a ring opening reaction. Examples of these functional groups of the compounds of crosslinker class II include alcoholic, amino, aldehyde, glycidic, isocyanate, carbonate or epichloro functions.

As examples of compounds of crosslinker class II include polyols such as ethyleneglycol, polyethyleneglycols such as diethyleneglycol, triethyleneglycol and tetraethyleneglycol, propyleneglycol, polypropyleneglycols such as dipropyleneglycol, tripropyleneglycol or tetrapropyleneglycol, 1,3-butanediol, 1,4-butanediol, 1,5-pentanediol, 2,4-pentanediol, 1,6-hexanediol, 2,5-hexanediol, glycerine, polyglycerin, trimethylolpropane, polyoxypropylene, oxyethylene-oxypropylene-block copolymer, sorbitan-fatty acid esters, polyoxyethylenesorbitan-fatty acid esters, pentaerythritol, polyvinylalcohol and sorbitol, aminoalcohols, for example ethanolamine, diethanolamine, triethanolamine or propanolamine, polyamine compounds, for example, ethylenediamine, diethylenetriamine, triethylenetetraamine, tetraethylenepentaamine or pentaethylenehexaamine, polyglycidyl ether compounds, such as, ethyleneglycoldiglycidyl ether, polyethyleneglycoldiglycidyl ether, glycerinediglycidyl ether, glycerinepolyglycidyl ether, pentaerithritolpolyglycidyl ether, propyleneglycoldiglycidyl ether, polypropyleneglycoldiglycidyl ether, neopentylglycoldiglycidyl ether, hexanediolglycidyl ether, trimethylolpropanepolyglycidyl ether, sorbitolpolyglycidyl ether, phthalic acid diglycidyl ester, adipinic acid diglycidyl ether, 1,4-phenylenebis(2-oxazoline), glycidol, polyisocyanates, in an aspect diisocyanates such as 2,4-toluenediioscyanate and hexamethylenediisocyanate, polyaziridine compounds, such as, 2,2-bishydroxymethylbutanol-tris[3-(1-aziridinyl)propionate], 1,6-hexamethylenediethyleneurea and diphenylmethane-bis-4,4′-N,N′-diethyleneurea, halogen epoxides for example epichloro- and epibromohydrin and α-methylepichlorohydrin, alkylenecarbonates, such as, 1,3-dioxo lane-2-one (ethylene carbonate), 4-methyl-1,3-dioxolane-2-one (propylene carbonate), 4,5-dimethyl-1,3-dioxolane-2-one, 4,4-dimethyl-1,3-dioxolane-2-one, 4-ethyl-1,3-dioxolane-2-one, 4-hydroxymethyl-1,3-dioxolane-2-one, 1,3-dioxane-2-one, 4-methyl-1,3-dioxane-2-one, 4,6-dimethyl-1,3-dioxane-2-one, 1,3-dioxolane-2-one, poly-1,3-dioxolane-2-one, polyquaternary amines such as condensation products from dimethylamines and epichlorohydrin. In further aspects compounds of the crosslinker class II may be, in addition, polyoxazolines such as 1,2-ethylenebisoxazoline, crosslinkers with silane groups such as gamma-glycidooxypropyltrimethoxysilane and gamma-aminopropyltrimethoxysilane, oxazolidinones such as 2-oxazolidinone, bis- and poly-2-oxazolidinone and diglycolsilicates.

Example of compounds of class III include hydroxyl or amino group-containing esters of (meth)acrylic acid, such as for example 2-hydroxyethyl(meth)acrylate, as well as hydroxyl or amino group-containing (meth)acrylamides, or mono(meth)allylic compounds of diols.

In aspects of an embodiment, the polymer beads are polymer beads, which are cross-linked by any of the above named crosslinkers of crosslinker class I. In one aspect, these are water soluble crosslinkers. In this context, N,N′-methylenebisacrylamide, polyethyleneglycoldi(meth)acrylate, triallylmethylammonium chloride, tetraallylammonium chloride (TAMAC) as well as allyinonaethyleneglycolacrylate made with 9 mol ethylene oxide per mol acrylic acid are appropriate.

H. Inverter or Inverter Blend

Some aspects of embodiments of the present invention relate to one or more oil-in-water emulsifiers, designated as activator or inverter, added to the fire protection and/or fire fighting additive. Suitable oil-in-water emulsifiers include, but are not limited to, natural surfactants (e.g., surfactants based on natural components such as fatty acids, coconut oil, . . . etc.), anionic surfactants, cationic surfactants, nonionic surfactants, amphoteric surfactants, or combinations thereof. Natural surfactants include, but are not limited to, coconut-based soap solutions. Anionic surfactants include, but are not limited to, dodecyl benzene sulfonic acid and its salts, alkyl ether sulfates and salts thereof, olefin sulfonates, phosphate esters, soaps, sulfosuccinates, and alkylaryl sulfonates. Cationic surfactants include, but are not limited to, alkoxylated cationic ammonium surfactants. Nonionic surfactants include, but are not limited to, alkoxylates of alkyl phenols and alcohols, alkanolamides, and alkyl polyglycocides. Amphoteric surfactants include, but are not limited to, imidazoline derivatives, betaines, and amine oxides.

Typically, ethoxylated fatty alcohols may be used as inverters, such as ethoxylated fatty alcohols that are produced from linear and/or branched fatty alcohols with an alkyl chain length of more than 9 carbon atoms. Also, inverters may be ethoxylation products of highly branched alcohols which can be obtained by oxo synthesis, such as, isotridecyl alcohol. In an aspect, an inverter may be an ethoxylation product of higher, single-branched alcohols which can be obtained by Guerbet synthesis.

In general, the fire protection and/or fire fighting additive is inverted before or during use into a fire protection and/or fire fighting composition. This may be achieved by adding one or more inverting emulsifiers (“inverters”) that ensure the wettability of the polymer-beads (e.g., polymer containing micelles) by a continuous aqueous phase. Ethoxylated fatty alcohols are conventionally used for this purpose, such as for example MARLIPAL® O13/50, an isodecanol ethoxylated with 5 mol of EO, available from Sasol North America Inc. However, the one or more inverters may include any one of ethoxylated fatty alcohol, ethoxylated fatty acid monoalkanolamide, ethoxylated fatty acid dialkanolamide, alkylpolyglycoside, or mixtures thereof.

In one aspect, a ratio of ethoxylated fatty alcohol to ethoxylated fatty acid mono- and/or dialkanolamide or to alkylpolyglycoside is from 1:10 to 10:1; in another aspect the ratio may be 1:3 to 3:1. The proportion of ethoxylated fatty acid mono- and/or dialkanolamide in the mixture generally falls as the degree of ethoxylation rises.

In an aspect, an ethoxylated fatty alcohol may be linear or branched and the alkyl chain having 8 to 30 carbon atoms, in another aspect having 8 to 22 carbon atoms, in yet another aspect having 10 to 18 carbon atoms, and in yet still another aspect 10 to 15 carbon atoms.

In an aspect where the ethoxylated fatty alcohol is ethoxylated with 5 to 9 mol of EO, an ethoxylated fatty alcohol has 10 to 15 carbon atoms; in another aspect 12 to 14 carbon atoms; in yet another aspect 13 carbon atoms.

In yet another aspect, an ethoxylated fatty acid mono- and/or dialkanolamide, the fatty acid moiety has 6 to 22 carbon atoms; in another aspect 10 to 18 carbon atoms; in yet another aspect 12 to 14 carbon atoms

I. Residual-Monomer Eliminator or Residual-Monomer Eliminator Blend

Some aspects of embodiments of the present invention relate to the fire protection and/or fire fighting additive and the one or more residual-monomer eliminators. To that end, after a conclusion of the polymerization, a residual-monomer eliminator may be added to the fire protection and/or fire fighting additive. The addition measured so that the content of residual-monomer in the resulting fire protection and/or fire fighting additive is less than 1,000 ppm.

Residual-monomer eliminators in the sense of the present invention are substances which modify the polymerizable monomers through a chemical reaction in such a manner that they are no longer polymerizable so that they are no longer monomers in the sense of the present invention. For this purpose, substances can be used which react with the double bond contained in the monomers and/or substances which can initiate a further polymerization.

In one aspect, the one or more residual-monomer eliminators may react with the double bond such as, for example, reducing agents. To that end, the one or more residual-monomer eliminators may be:
substances from the group of acid or neutral salts of the acids derived from sulfur with an oxidation number less than VI, such as, sodium dithionite, sodium thiosulfate, sodium sulfite, or sodium disulfide; and/or
substances with a hydrogen sulfide group, such as sodium hydrogen sulfide or compounds from the groups of thiols, such as mercaptoethanol, dodecylmercaptan, thiopropionic acid or salts of thiopropionic acid or thiopropane sulfonic acid, or salts of thiopropane sulfonic acid; and/or
substances from the group of amines, such as from the group of amines with low volatility, in an aspect diisopropanolamine, or aminoethylethanolamine; and/or
substances from the group which include Bunte salts, formamidine sulphinic acid, sulfur dioxide, aqueous and organic solutions of sulfur dioxide, or thiourea.

Those skilled in the art will recognize that a mixture of at least two residual monomers from one or more groups can also be used.

For the reduction of the residual monomer content through a newly initiated polymerization, it is possible to use the aforementioned reducing agents in combination with oxidizing agents, such as substances from the group of peroxodisulfates or hydroperoxides, such as hydrogen peroxide. In further aspects suitable substances for the reduction of the residual monomer content may include compounds that decompose at high temperatures into radicals, such as substances from the group of azo compounds, peroxides, or peroxodisulfates.

In one aspect, about 100 ppm to about 20,000 ppm; in another aspect about 200 ppm to 5,000 ppm, and in yet another aspect 500 to 3,000 ppm of residual-monomer eliminator, based on the total weight of that fire protection and/or fire fighting additive, may be used.

J. Chelator or Chelator Blend

Aspects of embodiments and embodiments of the present invention relate to the fire protection and/or fire fighting additive and the one or more chelators to reducing harmful effects of hardness components in service water. Typically, a polyvalent metal cation or compound such as a calcium, a magnesium, an iron, a manganese, a molybdenum, etc. cation or compound, or mixtures thereof, can be present in service water. Such compounds or cations can interfere with the emulsification, dispersion, and/or polymerization. A chelating agent can effectively complex and remove such compounds or cations from service water and can reduce or eliminate the inappropriate interaction with active ingredients including the nonionic surfactants of the invention. Suitable chelators for use in the present invention include, but are not limited to, organic compounds, inorganic compounds, or combinations thereof. In aspects of one embodiment, the chelators are organic. Nonlimiting examples of organic chelators include the salts or acid form of nitriloacetic acid and its derivatives, amino carboxylates, organic phosphonates, amides, polycarboxylates, salicylates and their derivatives, sodium aluminosilicates, zeolites, and derivatives of polyamino compounds or mixtures thereof. Nonlimiting examples of nitriloacetic acid derivatives include sodium nitriloacetate and magnesium nitriloacetate. Nonlimiting examples of amino carboxylates include sodium iminosuccinates. Nonlimiting examples of organic phosphonates include amino tri(methylene phosphonate), hydroxyethylidene diphosphonate, diethylenetriamine penta-(methylenephosphonate), and ethylenediamine tetra(methylene-phosphonate). Nonlimiting examples of polycarboxylates include citric acid and it salts and derivatives, sodium glutarate, potassium succinate, polyacrylic acid and its salts and derivatives, and copolymers. Nonlimiting examples of polyamino compounds include ethylene diamine (e.g., ethylenediaminetetraacetic acid {EDTA}), ethylene triamine (e.g., diethyltriaminepentaacetic acid {DTPA}), hydroxyethylene diamine (e.g., N-hydroxyethyliminodiacetic acid, nitrolotriacetic acid {NTA}, N-hydroxyethyl-ethylenediaminetriacetic acid {HEDTA}), their salts, their derivatives, the like, or combinations thereof. In aspects of another embodiment, the chelators are inorganic.

Nonlimiting examples of inorganic chelators include sodium tripolyphosphate, sodium carbonate, sodium pyrophosphate, potassium pyrophosphate, magnesium phosphate, tetramethylammonium phosphate, potassium carbonate, sodium phosphate, or combinations thereof.

In aspects of yet another embodiment, the fire protection and/or fire fighting additive comprises at least one chelator selected from polyacrylates or their copolymers, iminodisuccinate, citrate, ethylenediamine or triamine derivatives, or mixtures thereof.

A number of commercially available chelators may be used in the present invention. Suitable commercially available chelators include, but are not limited to, sodium iminodisuccinate sold under the trade designation BAYPURE®, available from Bayer Corporation (Baytown, Tex.), such as BAYPURE® CX100.

### II. FIRE PROTECTION AND/OR FIRE FIGHTING COMPOSITIONS

As noted, aspects of embodiments and embodiments of the present invention relate to fire protection and/or fire fighting compositions. To that end, a fire protection and/or fire fighting compositions include (e.g., is made using) a fire protection and/or fire fighting additive and one or more fire-extinguishing agents. An amount of the fire protection and/or fire fighting additive an effect amount for making fire protection and/or fire fighting compositions have properties that are appropriate for the task at hand. For example, in one aspect an effect amount of the fire protection and/or fire fighting additive may be from about 0.1 wt % to about 5 wt %, based on the total weight of the composition; and in another aspect an effective amount may be from about 1 wt % to about 3 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive have been described in detail in the section entitled “Acrylamide-Free, Fire Protection and/or Fire Fighting Additive.”

Surprisingly, in an aspect, the fire protection and/or fire fighting composition exhibit exceptionally low corrosion properties. For example, in one aspect, when contacted with any one of a 4130 steel or yellow brass, the corrosion rate is less than about 5 mils/yr while when contacted with AZ31B magnesium alloy, the corrosion rate is less than about 4 mils/yr. Even more surprising, in another aspect, when contacted with any one of a 4130 steel, or yellow brass, the corrosion rate is less than about 1 mil/yr., while when contacted with 2024-T3 aluminum, the corrosion rate is less than about 2 mils/yr.

### III. METHODS OF MAKING THE ACRYLAMIDE-FREE, FIRE PROTECTION AND/OR FIRE FIGHTING ADDITIVE

Aspects of embodiments relate to a process for making an additive combinable with a fire-extinguishing agent, such as water, for use in a fire protection and/or fire fighting composition. The produced additive may include acrylamide-free, crosslinked, and water-swellable polymer beads dispersed throughout a continuous water immiscible phase. The process includes the steps of forming an aqueous monomer solution, forming aqueous monomer beads, polymerizing the monomer solution to form dispersed water-swellable polymer beads, and adding an inverter and/or a residual-monomer eliminator.

For example, an aqueous monomer solution may be produced by mix water, one or more monomers, one or more neutralizer, one or more chelating agents, one or more cross-linkers, one or more initiator including one or more thermal initiators. Subsequently, one or more water immiscible phases and one or more surfactants are mixed and to aqueous monomer solution and then stirred to fully mix into a water-in-oil emulsion. After mixing, the water-in-oil emulsion is homogenized by homogenizer and then freed of dissolved oxygen by nitrogen purging for at least 60 minutes. After nitrogen purging, either autogenous polymerization starts and/or redox initiated polymerization starts. The exothermic heat of autogenous polymerization and/or redox initiated polymerization raises the temperature of the oxygen-free water-in-oil emulsion to the reaction temperature for the thermal initiator. Then, the temperature of the oxygen-free water-in-oil emulsion including further polymerized reaction product rises to about 100° C. as a result of further exothermic heat of polymerization. At about 60° C. as a monomer scavenger is added. After cooling, one or more inverters are added into the water-in-oil emulsion including the polymerized reaction product. The water-in-oil emulsion including the polymerized reaction product is filtered using 50 micron screener. Reference may be made to Examples 1-3 below for some further nonlimiting specific examples.

### IV. METHODS OF USING THE ACRYLAMIDE-FREE, FIRE PROTECTION AND/OR FIRE FIGHTING COMPOSITION

In yet still other aspects of embodiments, a sufficient amount of a fire protection and/or fire fighting composition is applied to a combustible object to prevent, retard, suppress, or extinguish a fire. The fire protection and/or fire fighting composition includes (e.g., is made using) a fire protection and/or fire fighting additive and one or more fire-extinguishing agents. An amount of the fire protection and/or fire fighting additive may be from about 0.1 wt % to about 5 wt %, based on the total weight of the composition. An amount of the one or more fire-extinguishing agents may be from about 95 wt % to about 99.9 wt % of one or more fire-extinguishing agents, based on the total weight of the composition. The fire protection and/or fire fighting additive may be from about 10 wt % to about 70 wt % of acrylamide-free, crosslinked, and water-swellable polymer prepared by inverse phase polymerization, in one aspect from about 10 wt % to about 80 wt % of water immiscible phase while in another aspect from about 20 wt % to about 80 wt % of water immiscible phase, from about 0.5 wt % to about 10 wt % of an emulsifier, from about 0.5 wt % to about 10 wt % of an inverter, and the remainder to 100 wt % of water, where the weight percent (wt %) of each is based on the total weight of the additive.

According to aspects of embodiment, fire protection and/or fire fighting compositions are formulated to attain a viscosity of at least about 100 mPa·s, measured using STP-4.5—Brookfield Viscosity (Revised Apr. 28, 2006, Revolutions Per Minute {abbreviated rpm, RPM, r/min, or r·min-1} at about 70° F. {about 21° C.}). According to another aspects, the fire protection and/or fire fighting compositions are formulated to attain over about 1,000 mPa·s, and according to yet another aspects to between about 5,000 mPa·s and about 50,000 mPa·s.

### V. DEVICES FOR USING THE ACRYLAMIDE-FREE, FIRE PROTECTION AND/OR FIRE FIGHTING ADDITIVE

Also as noted, in aspects, the viscosity of the fire protection and/or fire fighting composition is such that the composition is flowable when subjected to the shear forces of any type of conventional fire fighting equipment while at the same time remain on a surface (e.g., such as any one of a vertical surface, sloped surface, projecting surface, a horizontal surface, or any combinations thereof) for a prevention of fire and/or to combat fire. Some such conventional equipment is described, for example, in the U.S. Pat. No. 5,989,446 (EP0774279B1) and in the German patent DE 299 04 848 U1. Other such equipment includes: a nozzle/eductor (Part#: TG15V5) designed to be used with existing water pump systems (e.g., a pump able to produce at least about 15 gallon per minute {GPM}) at about 1% for suppression and wet lines or about 2% for home and structure protection and defensible perimeters; a 5 gallon pro nozzle/eductor (part#: TG20PK5 {20 GPM}); a 1 gallon pro nozzle/eductor (part#: TG20PK1 {20 GPM}); TFT® PRO/pak (part#: TFTPP); THERMO-GEL® PRO/pak tip (part#: TGPPT); FIREDOS® water driven proportioners that may be mounted to fire trucks, irrigation systems or portable tanks (also available from MSR Dosiertechnik GmbH, Wölfersheim, Germany); a THERMO-GEL® mobile gel plant; a THERMO-GEL® home fire protection system; a THERMO-GEL® homeowner fire protection kit (part#: TG200LHK), each available from Thermo Technologies, LLC (Bismarck, N. Dak.).

Some of such equipment may be used in combination with fixed-wing aircraft such as, for example, without limitation, single engine air tankers (SEAT), modular airborne firefighting system (MAFFS), military airborne firefighting system 2nd Generation (MAFFS 2), or fixed wing tankers. Likewise, some of such equipment may be used in combination with helicopters.

The disclosure and figures of the above mentioned documents relating to devices and/or equipment for using an acrylamide-free, fire protection and/or fire fighting additive is hereby incorporated by reference.

### VI. TEST METHODS

Wildland Fire Chemicals

Standard Test Procedures—The United States Department of Agriculture Forest Service (USDA Forest Service) has developed standard test procedures to evaluated and qualified wildland fire chemical products. The USDA Forest Service's Wildland Fire Chemical Systems (WFCS) at the Missoula Technology and Development Center in Missoula, Mont. (MT), USA and the San Dimas Technology and Development Center in San Dimas, Calif. (CA), USA are just two of the several location involved in developing standard test procedures and evaluating and qualifying. Several documents together describe the process and requirements for evaluating and qualifying each product type. Examples USDA Forest Service publications include
Specification for Water Enhancer for Wildland Firefighting, Helicopter Bucket and Ground Application, draft specification, December 2002, Pages 1-28, 5100-306a Draft, USDA Forest Service, Missoula Technology and Development Center, Missoula, Mont., USA;
Specification for Long Term Retardant, Wildland Fire, Aircraft or Ground Application, specification, July 1999, Pages 1-21, 5100-304b, USDA Forest Service, San Dimas Technology and Development Center, San Dimas, Calif., USA;
Manufacturer Submission Procedures for Qualification Testing of Wildland Fire Chemical Products, guideline, July 1999, Pages 1-12, 5100 Fire Management, 9951 1802-SDTDC, USDA Forest Service, San Dimas Technology and Development Center, San Dimas, Calif., USA;
Standard Test Procedures for the Evaluation of Wildland Fire Chemical Products, specifications, December 2000, Pages 1-55, 5100 Fire Management, 0051 1807-SDTDC, USDA Forest Service, San Dimas Technology and Development Center, San Dimas, Calif., USA and Wildland Fire Chemicals Systems at Missoula Technology and Development Center, Missoula, Mont., USA;
International Specification for Water Enhancers for Wildland Firefighting, Ground Application, specification, DRAFT December 2002, Pages 1-28, Specification 5100-306a (To supersede Specification 5100-306 September 1987), San Dimas Technology and Development Center, San Dimas, Calif., USA and Wildland Fire Chemicals Systems at Missoula Technology and Development Center, Missoula, Mont., USA; and
Specification for Water Enhancers (Gels) For Wildland Firefighting, specification, Jun. 1, 2007, Pages 1-39, Specification 5100-306a (Superseding Specification 5100-306 September 1987), San Dimas Technology and Development Center, San Dimas, Calif., USA and Wildland Fire Chemicals Systems at Missoula Technology and Development Center, Missoula, Mont., USA.

The test procedures are revised as necessary to maintain current descriptions and incorporate changes due to specification revisions. A revision date is included in the link to each procedure to allow users to determine when there have been updates to the procedures. See e.g., http://www.fs.fed.us/rm/fire/wfcs/tests/index.htm reproduced below.
Standard Test Procedures, Section 1—Health, Safety, and the Environment
   STP 1.1—Review of Disclosure Information (Revised Apr. 27, 2006) http://www.fs.fed.us/rm/fire/wfcs/tests/stp01_{—}1.htm
   STP 1.2—Risk Assessment (Revised Nov. 20, 2006) http://www.fs.fed.us/rm/fire/wfcs/tests/stp01_{—}2.htm
   STP 1.3—Mammalian Toxicity (Revised Apr. 19, 2006) http://www.fs.fed.us/rm/fire/wfcs/tests/stp01_{—}3.htm
   STP 1.4—Biodegradability (Revised Apr. 19, 2006) http://www.fs.fed.us/rm/fire/wfcs/tests/stp01_{—}4.htm
   STP 1.5—Fish Toxicity (Revised May 7, 2007) http://www.fs.fed.us/rm/fire/wfcs/tests/stp01_{—}5.htm
   STP 1.6—Photo-Enhanced Fish Toxicity (Revised Apr. 26, 2006) http://www.fs.fed.us/rm/fire/wfcs/tests/stp01_{—}6.htm
   STP 1.7—Cleveland Open Cup Flash Point and Fire Point (Revised Apr. 19, 2006) http://www.fs.fed.us/rm/fire/wfcs/tests/stp01_{—}7.htm
Standard Test Procedures, Section 2—Fire Tests
   STP 2.1—Combustion Retarding Effectiveness http://www.fs.fed.us/rm/fire/wfcs/tests/documents/stp_tm02.pdf
   STP 2.2—Lateral Ignition and Flame Spread Test (Revised May 30, 2007) http://www.fs.fed.us/rm/fire/wfcs/tests/stp02_{—}2.htm
Standard Test Procedures, Section 3—Determination of Optimum Mixing Test
   STP 3.1—Long-Term Retardants http://www.fs.fed.us/rm/fire/wfcs/tests/documents/stp_tm03.pdf
   STP 3.2—Class A Foams
   STP 3.3—Water Enhancers
Standard Test Procedures, Section 4—Physical Properties
   STP-4.1—Salt Content (Revised May 1, 2006) http://www.fs.fed.us/rm/fire/wfcs/tests/stp04_{—}1.htm
   STP-4.2—Refractometer Reading (Revised Apr. 28, 2006) http://www.fs.fed.us/rm/fire/wfcs/tests/stp04_{—}2.htm
   STP-4.3—Density (Revised Feb. 28, 2006) http://www.fs.fed.us/rm/fire/wfcs/tests/stp04_{—}3.htm
   STP-4.4—pH (Revised Apr. 28, 2006) http://www.fs.fed.us/rm/fire/wfcs/tests/stp04_{—}4.htm
   STP-4.5—Brookfield Viscosity (Revised Apr. 28, 2006) http://www.fs.fed.us/rm/fire/wfcs/tests/stp04_{—}5.htm
   STP-4.6—Marsh Funnel Flow-Through (Revised May 1, 2006) http://www.fs.fed.us/rm/fire/wfcs/tests/stp04_{—}6.htm
   STP-4.7—Product Fluidity (Revised May 2, 2006) http://www.fs.fed.us/rm/fire/wfcs/tests/stp04_{—}7.htm
Standard Test Procedures, Section 5—Material Effects
   STP 5.1—Uniform Corrosion Test http://www.pyrogen.com/00511807_WildlandChem9.pdf
   STP 5.2—Intergranular Corrosion Tests
   STP 5.3—Effects on Non-Metallics (Revised Nov. 30, 2006) http://www.fs.fed.us/rm/fire/wfcs/tests/documents/stp_{—}05_{—}3.pdf
   STP 5.4—Abrasion Test http://www.fs.fed.us/rm/fire/wfcs/tests/documents/stp_tm07.pdf
Standard Test Procedures, Section 6—Product Stability Tests
   STP 6.1—Outdoor Storage http://www.fs.fed.us/rm/fire/wfcs/tests/documents/stp_tm04.pdf
   STP 6.2—Viscosity Loss
   STP 6.3—Resistance to Microbial Growth
Standard Test Procedures, Section 7—Pumpability Test http://www.fs.fed.us/rm/fire/wfcs/tests/documents/stp_tm06.pdf
Standard Test Procedures, Section 8—Class A Foam Effectiveness Tests
   STP 8.1—Surface Tension (Revised May 4, 2006) http://www.fs.fed.us/rm/fire/wfcs/tests/stp08_{—}1.htm
   STP 8.2—Wetting Ability (Revised May 15, 2006) http://www.fs.fed.us/rm/fire/wfcs/tests/stp08_{—}2.htm
   STP 8.3—Foaming Ability (Revised May 5, 2006) http://www.fs.fed.us/rm/fire/wfcs/tests/stp08_{—}3.htm
   STP 8.4—Foam Expansion
   STP 8.5—Foam Drain Time
   STP 8.6—Miscibility (Revised May 9, 2006) http://www.fs.fed.us/rm/fire/wfcs/tests/stp08_{—}6.htm
Standard Test Procedures, Section 9—Water Enhancer Effectiveness Tests
   STP-9.1—Enhanced Water Mixture Retention on a Dowel Tree (Revised May 15, 2006) http://www.fs.fed.us/rm/fire/wfcs/tests/stp09_{—}1.htm
   STP-9.2—Enhanced Water Mixture Evaporation Rate (Revised May 15, 2006) http://www.fs.fed.us/rm/fire/wfcs/tests/stp09_{—}2.htm
   STP-9.3—Water Retention of Enhanced Water Mixtures (Drain Rate) (Revised May 15, 2006) http://www.fs.fed.us/rm/fire/wfcs/tests/stp09_{—}3.htm
   STP-9.4—Photo-Degradation (Revised May 16, 2006) http://www.fs.fed.us/rm/fire/wfcs/tests/stp09_{—}4.htm
   STP-9.5—Effect of Water Quality (Revised May 16, 2006) http://www.fs.fed.us/rm/fire/wfcs/tests/stp09_{—}5.htm
   STP-9.6—Effect of Water Temperature (Revised May 16, 2006) http://www.fs.fed.us/rm/fire/wfcs/tests/stp09_{—}6.htm
Standard Test Procedures, Section 10—Visibility Test
   STP 10.1—Laboratory Visibility Tests
   STP 10.2—Opacity
   STP 10.3—Field Visibility http://www.fs.fed.us/rm/fire/wfcs/tests/documents/stp_tm08.pdf
Standard Test Procedures, Section 11—Air Drop Characteristics Test http://www.fs.fed.us/rm/fire/wfcs/tests/documents/stp_tm09.pdf
Standard Test Procedures, Section 12—Operational Field Evaluation Test http://www.fs.fed.us/rm/fire/wfcs/tests/documents/stp_tm10.pdf
   Ground Observer Form http://www.fs.fed.us/rm/fire/wfcs/tests/documents/grndform.pdf
   Air Observer Form http://www.fs.fed.us/rm/fire/wfcs/tests/documents/airform.pdf
Standard Test Procedures, Section 13—Lot Acceptance and Quality Assurance http://www.fs.fed.us/rm/fire/wfcs/laqa.htm
Standard Test Procedures, Appendix—Sources of Referenced Documents http://www.fs.fed.us/rm/fire/wfcs/tests/sources.htm
Glossary http://www.fs.fed.us/rm/fire/wfcs/tests/glossary.htm

Viscosity

The viscosity, or resistance to flow, of a material can be determined by a rotational viscometer using STP-4.5—Brookfield Viscosity (Revised Apr. 28, 2006). The viscometer can also be used to approximate other flow characteristics by relating viscosity and flow for a known composition.

Specific rotational speed, the spindle used, and the temperature of the test sample can have a impact on the value determined, it is best to use the same conditions throughout a test series. Unless stated other wise most properties, including viscosity, are measured at about 70° F. (about 21° C.).

The viscosity of long-term retardant products is normally measured using a #2 spindle for products having a viscosity between 1 and 500 centipoise (cP) and a #4 spindle for products having a viscosity greater than 500 cP; although the #3 spindle may also be used when the upper values are expected to be less than 2,000 cP

Although STP-4.5—Brookfield Viscosity (Revised Apr. 28, 2006) calls for a Brookfield model LVF viscometer and spindle set, it will be appreciated that any of a variety of commercially available viscometers/rheometers models and spindle sets including, without limitation, any of models LVT, LVDV-E, LVDV-I Prime, LVDV-II+PRO, and LVDV-III Ultra available form Brookfield Engineering Laboratories, Inc. (Middleboro, Mass. {Mass.}, USA) may be used.

Reference may be made to:
American Society for Testing and Materials. Standard Test Methods for Rheological Properties of Non-Newtonian Materials by Rotational (Brookfield type) Viscometer; D2196-05; and
National Wildfire Coordinating Group and USDA Forest Service. Lot

Acceptance, Quality Assurance, and Field Quality Control for Fire Retardant Chemicals, Sixth Edition. 2000.

Corrosion Testing

The corrosion characteristics any one of 2024-T3 aluminum, 4130 steel, yellow brass and AZ31B magnesium in contact with a material can be determined using STP 5.1—Uniform Corrosion Test (Revised Nov. 24, 2000).

### VII. EXAMPLES

### Abbreviations for Some Ingredients

| | |
|---|---|
| AMPS: | 2-acrylamido-2-methylpropane sulfonic acid comonomer |
| TAMAC: | Triallyl methyl ammonium chloride cross-linker |
| ABAH: | 2,2′-azo-bis-amidinopropane-dihydrochloride initiator |
| NaPS: | Sodium persulfate (Na₂S₂O₈) initiator |

### Example 1

Aqueous monomer solution is produced from the following compositions:

| | | |
|---|---|---|
| 557.1 | g | Water; |
| 28.8 | g | AMPS, sodium salt (50 wt % concentration in water); |
| 352 | g | Acrylic acid; |
| 352 | g | Sodium hydroxide (50 wt % concentration in water); |
| 0.5 | g | Thioglycolic acid; |
| 1.1 | g | VERSENEX ® 80 Chelating Agent (The Dow Chemical |
| | | Company, Midland, MI); |
| 3.8 | g | TAMAC; |
| 0.5 | g | ABAH (10 wt % concentration in water); and |
| 1.0 | g | NaPS (10 wt % concentration in water). |

Subsequently, 360 g of OLEOCAL® ME 112 mixed fatty acid methyl esters (produced from low erucic acid canola oil by Lambent Technologies Corp., Gurnee, Ill.) and 30 g of HYPERMER™ 1083 polymeric surfactant (Croda Europe Limited, East Yorkshire, UK) are added to the aqueous monomer solution and then stirred to fully mix into a water-in-oil emulsion. After mixing, the water-in-oil emulsion is homogenized using a homogenizer and then freed of dissolved oxygen by nitrogen purging for at least 60 minutes. After nitrogen purging, autogenous polymerization starts at from about 20° C. to 25° C. and the exothermic heat of the autogenous polymerization slowly raises the temperature of the oxygen-free water-in-oil emulsion to the reaction temperature for the thermal initiator(s). At from about the reaction temperature for the thermal initiator(s), the temperature of the oxygen-free water-in-oil emulsion rapidly rises to about 100° C. as a result of further polymerization involving thermal initiator(s), and then slowly cools. At about 60° C. to about 65° C., extra water (about 10%) is distilled under vacuum (about 400 to about 500 mmHg). Then, at about 50° C., 7.5 ml of 30 wt % sodium metabisulfate is added as a monomer scavenger. After cooling, 32 g of TERGITOL™ 15-S-5 surfactant and 32 g of TERGITOL™ 15-S-9 Surfactant (The Dow Chemical Company, Midland, Mich.) are added into the water-in-oil emulsion including the polymerized reaction product. The water-in-oil emulsion including the polymerized reaction product is filtered using a 50 micron screener.

### Example 2

Aqueous monomer solution is produced from the following compositions:

| | |
|---|---|
| 416.8 g | Water; |
| 32.0 g | AMPS, sodium salt (50 wt % concentration in water); |
| 336 g | Acrylic acid; |
| 496 g | Potassium hydroxide (45 wt % concentration in water); |
| 0.5 g | Thioglycolic acid; |
| 1.1 g | VERSENEX ® 80 Chelating Agent; |
| 4.5 g | TAMAC; |
| 0.2 g | ABAH (10 wt % concentration in water); and |
| 1.0 g | NaPS (10 wt % concentration in water). |

Subsequently, 368 g of OLEOCAL® ME 112 mixed fatty acid methyl esters (produced from low erucic acid canola oil by Lambent Technologies Corp., Gurnee, Ill.) and 28 g of HYPERMER™ 1083 polymeric surfactant (Croda Europe Limited, East Yorkshire, UK) are added to the aqueous monomer solution and then stirred to fully mix into a water-in-oil emulsion. After mixing, the water-in-oil emulsion is homogenized using a homogenizer and then freed of dissolved oxygen by nitrogen purging for at least 60 minutes. After nitrogen purging, autogenous polymerization starts at from about 20° C. to 25° C. and the exothermic heat of the autogenous polymerization slowly raises the temperature of the oxygen-free water-in-oil emulsion to the reaction temperature for the thermal initiator(s). At from about the reaction temperature for the thermal initiator(s), the temperature of the oxygen-free water-in-oil emulsion rapidly rises to about 100° C. as a result of further polymerization involving thermal initiator(s), and then slowly cools. At about 60° C. to about 65° C., extra water (about 10%) is distilled under vacuum (about 400 to about 500 mmHg). Then, at about 50° C., 7.5 ml of 30 wt % sodium metabisulfate is added as a monomer scavenger. After cooling, 32 g of TERGITOL™ 15-5-5 surfactant and 32 g of TERGITOL™ 15-S-9 Surfactant (The Dow Chemical Company, Midland, Mich.) are added into the water-in-oil emulsion including the polymerized reaction product. The water-in-oil emulsion including the polymerized reaction product is filtered using 50 micron screener.

### Example 3

Aqueous monomer solution is produced from the following compositions:

| | |
|---|---|
| 416.8 g | Water; |
| 32.0 g | AMPS, sodium salt (50 wt % concentration in water); |
| 336 g | Acrylic acid; |
| 496 g | Potassium hydroxide (45 wt % concentration in water); |
| 0.5 g | Thioglycolic acid; |
| 1.1 g | VERSENEX ® 80 Chelating Agent; |
| 4.5 g | TAMAC; |
| 0.2 g | ABAH (10 wt % concentration in water); and |
| 1.0 g | NaPS (10 wt % concentration in water). |

Subsequently, 368 g of OLEOCAL® ME 112 mixed fatty acid methyl esters (produced from low erucic acid canola oil by Lambent Technologies Corp., Gurnee, Ill.) and 28 g of HYPERMER™ 1083 polymeric surfactant (Croda Europe Limited, East Yorkshire, UK) are added to the aqueous monomer solution and then stirred to fully mix into a water-in-oil emulsion. After mixing, the water-in-oil emulsion is homogenized using a homogenizer and then freed of dissolved oxygen by nitrogen purging for at least 60 minutes. The polymerization starts at from about 20° C. to 25° C. by adding 0.5 ml of 1 wt % tert-butyl hydroperoxide solution to the oxygen-free water-in-oil emulsion. The exothermic heat of the polymerization raises the temperature of the oxygen-free water-in-oil emulsion to the reaction temperature for the thermal initiator(s). At from about the reaction temperature for the thermal initiator(s), the temperature of the oxygen-free water-in-oil emulsion rapidly rises to about 100° C. as a result of further polymerization involving thermal initiator(s), and then slowly cools. At about 60° C. to about 65° C., extra water (about 10%) is distilled under vacuum (about 400 to about 500 mmHg). Then, at about 50° C., 7.5 ml of 30 wt % sodium metabisulfate is added as a monomer scavenger. After cooling, 32 g of TERGITOL™ 15-S-5 surfactant and 32 g of TERGITOL™ 15-S-9 Surfactant (The Dow Chemical Company, Midland, Mich.) are added into the water-in-oil emulsion including the polymerized reaction product. The water-in-oil emulsion including the polymerized reaction product is filtered using 50 micron screener.

### Examples 4 Through 32

In Examples 4 through 32, the procedure of Example 1 is substantially repeated except that in place of the ABAH (2,2′-azo-bis-amidinopropane-dihydrochloride) initiator, the initiator in the amount listed Table 1 below is used.

TABLE 1
Examples 4 through 32

| | | Initiator |
|---|---|---|
| | | Amount |
| Example No. | Initiator | Grams (g) |
| Example 4 | Vazo ® 44WSP | 0.13-13. |
| | 2,2′-azobis-(N,N′-dimethyleneisobutyramidine)dihydrochloride | |
| Example 5 | Vazo ® 68WSP | 0.13-13. |
| | ACVA: 4,4′-azobis(4-cyanovaleric acid) | |
| Example 6 | 1-1′-azobiscyclohexanecarbonitrile) | 0.13-6.5 |
| Example 7 | 2-2′-azobisisobutyronitrile | 0.13-6.5 |
| Example 8 | 2-2′-azobis(2-methylpropionamidine) dihydrochloride | 0.13-13. |
| Example 9 | 2-2′-azobis(2-methylbutyronitrile) | 0.13-6.5 |
| Example 10 | 2-2′-azobis(propionitrile) | 0.13-6.5 |
| Example 11 | 2-2′-azobis(2,4-dimethylvaleronitrile) | 0.13-6.5 |
| Example 12 | 2-2′-azobis(valeronitrile) | 0.13-6.5 |
| Example 13 | 2,2′-azobis[2-methyl-N-(2-hydroxyethyl)propionamide] | 0.13-6.5 |
| Example 14 | 4,4′-azobis(4-cyanopentanoicacid) | 0.13-13. |
| Example 15 | 2,2′-azobis(N,N′-dimethyleneisobutyramidne) | 0.13-6.5 |
| Example 16 | 2-(carbamoy1azo)-isobutyronitrile | 0.13-6.5 |
| Example 17 | 2,2′-azobis(4-methoxy-2,4-dimethylpentanenitrile) | 0.13-6.5 |
| Example 18 | 2,2′-azobis(2,4-dimethylpentanenitrile) | 0.13-6.5 |
| Example 19 | 2,2′-azobis(2.methylpropanimidamide)•2HCl | 0.13-13. |
| Example 20 | 2,2′-azobis(isobutyronitrile) | 0.13-6.5 |
| Example 21 | 2,2′-azobis(2-methyl-butanenitrile) | 0.13-6.5 |
| Example 22 | 4,4′-azobis(4-cyanopentanoic acid) | 0.13-13. |
| Example 23 | 1,1′-azobis(cyclohexane-carbonitrile) | 0.13-6.5 |
| Example 24 | 2,2′-azobis(2-acetoxypropane) | 0.13-6.5 |
| Example 25 | 2-(tert-butylazo)-4-methoxy-2,4-dimethylpentanenitrile | 0.13-6.5 |
| Example 26 | 2-(tert-butylazo)-2,4-dimethylpentanenitrile | 0.13-6.5 |
| Example 27 | 4-(tert-butylazo)-4-cyanopentanoic acid | 0.13-13. |
| Example 28 | 2-(tert-butylazo)isobutyronitrile | 0.13-6.5 |
| Example 29 | 2-(tert-butylazo)-2-methylbutanenitrile | 0.13-6.5 |
| Example 30 | 1-(tert-amylazo)cyclohexanecarbonitrile | 0.13-6.5 |
| Example 31 | 1-(tert-butylazo)cyclohexanecarbonitrile | 0.13-6.5 |
| Example 32 | 1-(tert-butylazo)-formamide | 0.13-6.5 |

### Examples 33 Through 61

In Examples 33 through 61, the procedure of Example 2 is substantially repeated except that in place of the ABAH (2,2′-azo-bis-amidinopropane-dihydrochloride) initiator, the initiator in the amount listed Table 2 below is used.

TABLE 2
Examples 33 through 61

| | | Initiator |
|---|---|---|
| | | Amount |
| Example No. | Initiator | Grams (g) |
| Example 33 | Vazo ® 44WSP | 0.13-13. |
| | 2,2′-azobis-(N,N′-dimethyleneisobutyramidine)dihydrochloride | |
| Example 34 | Vazo ® 68WSP | 0.13-13. |
| | ACVA: 4,4′-azobis(4-cyanovaleric acid) | |
| Example 35 | 1-1′-azobiscyclohexanecarbonitrile) | 0.13-6.5 |
| Example 36 | 2-2′-azobisisobutyronitrile | 0.13-6.5 |
| Example 37 | 2-2′-azobis(2-methylpropionamidine) dihydrochloride | 0.13-13. |
| Example 38 | 2-2′-azobis(2-methylbutyronitrile) | 0.13-6.5 |
| Example 39 | 2-2′-azobis(propionitrile) | 0.13-6.5 |
| Example 40 | 2-2′-azobis(2,4-dimethylvaleronitrile) | 0.13-6.5 |
| Example 41 | 2-2′-azobis(valeronitrile) | 0.13-6.5 |
| Example 42 | 2,2′-azobis[2-methyl-N-(2-hydroxyethyl)propionamide] | 0.13-6.5 |
| Example 43 | 4,4′-azobis(4-cyanopentanoicacid) | 0.13-13. |
| Example 44 | 2,2′-azobis(N,N′-dimethyleneisobutyramidne) | 0.13-6.5 |
| Example 45 | 2-(carbamoy1azo)-isobutyronitrile | 0.13-6.5 |
| Example 46 | 2,2′-azobis(4-methoxy-2,4-dimethylpentanenitrile) | 0.13-6.5 |
| Example 47 | 2,2′-azobis(2,4-dimethylpentanenitrile) | 0.13-6.5 |
| Example 48 | 2,2′-azobis(2.methylpropanimidamide)•2HCl | 0.13-13. |
| Example 49 | 2,2′-azobis(isobutyronitrile) | 0.13-6.5 |
| Example 50 | 2,2′-azobis(2-methyl-butanenitrile) | 0.13-6.5 |
| Example 51 | 4,4′-azobis(4-cyanopentanoic acid) | 0.13-13. |
| Example 52 | 1,1′-azobis(cyclohexane-carbonitrile) | 0.13-6.5 |
| Example 53 | 2,2′-azobis(2-acetoxypropane) | 0.13-6.5 |
| Example 54 | 2-(tert-butylazo)-4-methoxy-2,4-dimethylpentanenitrile | 0.13-6.5 |
| Example 55 | 2-(tert-butylazo)-2,4-dimethylpentanenitrile | 0.13-6.5 |
| Example 56 | 4-(tert-butylazo)-4-cyanopentanoic acid | 0.13-13. |
| Example 57 | 2-(tert-butylazo)isobutyronitrile | 0.13-6.5 |
| Example 58 | 2-(tert-butylazo)-2-methylbutanenitrile | 0.13-6.5 |
| Example 59 | 1-(tert-amylazo)cyclohexanecarbonitrile | 0.13-6.5 |
| Example 60 | 1-(tert-butylazo)cyclohexanecarbonitrile | 0.13-6.5 |
| Example 61 | 1-(tert-butylazo)-formamide | 0.13-6.5 |

### Examples 62 Through 90

In Examples 62 through 90, the procedure of Example 3 is substantially repeated except that in place of the ABAH (2,2′-azo-bis-amidinopropane-dihydrochloride) initiator, the initiator in the amount listed Table 3 below is used.

TABLE 3
Examples 62 through 90

| | | Initiator |
|---|---|---|
| | | Amount |
| Example No. | Initiator | Grams (g) |
| Example 62 | Vazo ® 44WSP | 0.13-13. |
| | 2,2′-azobis-(N,N′-dimethyleneisobutyramidine)dihydrochloride | |
| Example 63 | Vazo ® 68WSP | 0.13-13. |
| | ACVA: 4,4′-azobis(4-cyanovaleric acid) | |
| Example 64 | 1-1′-azobiscyclohexanecarbonitrile) | 0.13-6.5 |
| Example 65 | 2-2′-azobisisobutyronitrile | 0.13-6.5 |
| Example 66 | 2-2′-azobis(2-methylpropionamidine) dihydrochloride | 0.13-13. |
| Example 67 | 2-2′-azobis(2-methylbutyronitrile) | 0.13-6.5 |
| Example 68 | 2-2′-azobis(propionitrile) | 0.13-6.5 |
| Example 69 | 2-2′-azobis(2,4-dimethylvaleronitrile) | 0.13-6.5 |
| Example 70 | 2-2′-azobis(valeronitrile) | 0.13-6.5 |
| Example 71 | 2,2′-azobis[2-methyl-N-(2-hydroxyethyl)propionamide] | 0.13-6.5 |
| Example 72 | 4,4′-azobis(4-cyanopentanoicacid) | 0.13-13. |
| Example 73 | 2,2′-azobis(N,N′-dimethyleneisobutyramidne) | 0.13-6.5 |
| Example 74 | 2-(carbamoy1azo)-isobutyronitrile | 0.13-6.5 |
| Example 75 | 2,2′-azobis(4-methoxy-2,4-dimethylpentanenitrile) | 0.13-6.5 |
| Example 76 | 2,2′-azobis(2,4-dimethylpentanenitrile) | 0.13-6.5 |
| Example 77 | 2,2′-azobis(2.methylpropanimidamide)•2HCl | 0.13-13. |
| Example 78 | 2,2′-azobis(isobutyronitrile) | 0.13-6.5 |
| Example 79 | 2,2′-azobis(2-methyl-butanenitrile) | 0.13-6.5 |
| Example 80 | 4,4′-azobis(4-cyanopentanoic acid) | 0.13-13. |
| Example 81 | 1,1′-azobis(cyclohexane-carbonitrile) | 0.13-6.5 |
| Example 82 | 2,2′-azobis(2-acetoxypropane) | 0.13-6.5 |
| Example 83 | 2-(tert-butylazo)-4-methoxy-2,4-dimethylpentanenitrile | 0.13-6.5 |
| Example 84 | 2-(tert-butylazo)-2,4-dimethylpentanenitrile | 0.13-6.5 |
| Example 85 | 4-(tert-butylazo)-4-cyanopentanoic acid | 0.13-13. |
| Example 86 | 2-(tert-butylazo)isobutyronitrile | 0.13-6.5 |
| Example 87 | 2-(tert-butylazo)-2-methylbutanenitrile | 0.13-6.5 |
| Example 88 | 1-(tert-amylazo)cyclohexanecarbonitrile | 0.13-6.5 |
| Example 89 | 1-(tert-butylazo)cyclohexanecarbonitrile | 0.13-6.5 |
| Example 90 | 1-(tert-butylazo)-formamide | 0.13-6.5 |

### Examples 91 Through 104

In Examples 91 through 104, the procedure of Examples 1-7 are substantially repeated except that in place of the NaPS (10 wt % concentration in water) initiator, the initiator (10 wt % concentration in water) in the amount listed Table 4 below is used.

TABLE 4
Examples 91 through 104

| | | Initiator |
|---|---|---|
| | | Amount |
| Example No. | Initiator | Grams (g) |
| Example 91 | ammonium persulfate (APS, {NH₄}₂S₂O₈) | 0.13-6.5 |
| | (substantially Example 1) | |
| Example 92 | ammonium persulfate (APS, {NH₄}₂S₂O₈) | 0.13-6.5 |
| | (substantially Example 2) | |
| Example 93 | ammonium persulfate (APS, {NH₄}₂S₂O₈) | 0.13-6.5 |
| | (substantially Example 3) | |
| Example 94 | ammonium persulfate (APS, {NH₄}₂S₂O₈) | 0.13-6.5 |
| | (substantially Example 4) | |
| Example 95 | ammonium persulfate (APS, {NH₄}₂S₂O₈) | 0.13-6.5 |
| | (substantially Example 5) | |
| Example 96 | ammonium persulfate (APS, {NH₄}₂S₂O₈) | 0.13-6.5 |
| | (substantially Example 6) | |
| Example 97 | ammonium persulfate (APS, {NH₄}₂S₂O₈) | 0.13-6.5 |
| | (substantially Example 7) | |
| Example 98 | potassium persulfate (KPS, K₂S₂O₈) | 0.13-6.5 |
| | (substantially Example 1) | |
| Example 99 | potassium persulfate (KPS, K₂S₂O₈) | 0.13-6.5 |
| | (substantially Example 2) | |
| Example 100 | potassium persulfate (KPS, K₂S₂O₈) | 0.13-6.5 |
| | (substantially Example 3) | |
| Example 101 | potassium persulfate (KPS, K₂S₂O₈) | 0.13-6.5 |
| | (substantially Example 4) | |
| Example 102 | potassium persulfate (KPS, K₂S₂O₈) | 0.13-6.5 |
| | (substantially Example 5) | |
| Example 103 | potassium persulfate (KPS, K₂S₂O₈) | 0.13-6.5 |
| | (substantially Example 6) | |
| Example 104 | potassium persulfate (KPS, K₂S₂O₈) | 0.13-6.5 |
| | (substantially Example 7) | |

### Example 105

TABLE 5
Evaporation rate comparison of water inverted water-in-oil emulsion
including the 2-propenamide free polymerized reaction product
The evaporation test is conducted in a convection oven at 150° C.

| | Weight Retention (by weight %) | | | |
|---|---|---|---|---|
| Evaporation | | 1% Example 1 | 2% Example 1 | 3% Example 1 |
| time | Tap | water-in-oil | water-in-oil | water-in-oil |
| (Minutes) | Water | emulsion | emulsion | emulsion |
| 0 | 100 | 100 | 100 | 100 |
| 10 | 96.11 | 96.44 | 97.45 | 98.03 |
| 20 | 81.4 | 85.03 | 87.85 | 90.12 |
| 30 | 70.11 | 75.6 | 79.87 | 83.40 |
| 45 | 55.82 | 62.84 | 68.11 | 72.84 |
| 60 | 40.5 | 48.92 | 55.48 | 60.12 |
| 90 | 4.6 | 15.82 | 26.84 | 38.64 |
| 120 | 0 | 0.2 | 7.21 | 14.82 |

The evaporation rate of water inverted water-in-oil emulsion including the polymerized reaction product as a fire protection/fire fighting agents are tested and compared to tap water from the city of Greensboro, N.C. For this test, a water-in-oil emulsion including the polymerized reaction product of Example 1 is used. Test results are summarized in Table 5 above. The nominal composition of the tap water from the city of Greensboro, N.C. is summarized in Table 9 below.

### Example 106

This test is conducted in accordance with Standard Test Procedure drafted by USDA forest service. The detail test procedure is described at section 4.10.1 of USDA Draft, Specification 5100-306a, Specification for Water Enhancers and Wildland Firefighting. For this test, water inverted water-in-oil emulsion including a acrylamide/sodium acrylate copolymerized reaction product (FIRECAPE® FP-47 water enhancer also sold under the name THERMO GEL® 200 L water enhancer) as well as water inverted water-in-oil emulsion including the 2-propenamide free polymerized reaction product of the above Examples are tested and compared. The test results are shown in the Table 6 below.

TABLE 6
Magnesium Corrosion Test Results

| | | | Magnesium Corrosion (mils/year) | | | |
|---|---|---|---|---|---|---|
| | Gel | Gel | Total | Total | Partial | Partial |
| | Concentration | Viscosity | Immersion | Immersion | Immersion | Immersion |
| Sample ID | (by wt %) | [cP]‡ | at 70° F. | at 120° F. | at 70° F. | at 120° F. |
| Water | 100.0% | ~1 | 1.20 | 0.70 | 1.00 | 0.60 |
| FIRECAPE ® | 1% | 8800 | 3.80 | 2.60 | 2.70 | 1.70 |
| FP-47 | 2% | 76000 | 3.60 | 3.80 | 2.30 | 2.00 |
| (Acrylamide/ | 100% | 2400 | 9.80 | 14.10 | 3.90 | 5.90 |
| acrylic acid | | | | | | |
| copolymer) | | | | | | |
| Example 1 | 1.5% | 20670 | 1.50 | 1.30 | 1.20 | 1.30 |
| | 3% | 78200 | 1.60 | 1.80 | 1.40 | 1.70 |
| | 100% | 560 | 3.20 | 4.10 | 2.50 | 3.40 |
| Example 2 | 1.5% | 21120 | 1.40 | 1.60 | 1.20 | 1.40 |
| | 3% | 78600 | 1.80 | 1.90 | 1.50 | 1.60 |
| | 100% | 520 | 3.10 | 4.20 | 2.70 | 3.20 |
| Example 3 | 1.5% | 4840 | 1.70 | 1.40 | 1.70 | 1.90 |
| | 3% | 43200 | 1.80 | 2.00 | 1.60 | 1.90 |
| | 100% | 520 | 3.1 | Becomes | 2.90 | Becomes |
| | | | | gelled | | gelled |
| | | | | within | | within |
| | | | | 2 days | | 2 days |

‡one (1) centipoise [cP] equals one (1) millipascal second [mPa · s]

### Example 107

Gel viscosities of water inverted water-in-oil emulsions are performed using tap water from the city of Greensboro, N.C. In general, these data are used to determine an amount of gel resulting from a water inverted water-in-oil emulsion usable to protect a structure from a fire. Test results are summarized in Tables 7 and Table 8 below.

TABLE 7
Gel Viscosity Test at 5 rpm Spindle Speed.
Greensboro Tap water was used as a test fluid.

| | Viscosities [cP], Brookfield, 5 rpm | | | |
|---|---|---|---|---|
| Mixed % | Example 1 | Example 2 | Example 3 | Spindle No.: |
| 1.00 | 2,720 | 2,830 | 380 | 3 |
| 1.50 | 20,670 | 21,120 | 4,840 | 4 |
| 2.00 | 43,200 | 43,100 | 13,200 | 5 |
| 2.50 | 58,900 | 57,630 | 27,420 | 6 |
| 3.00 | 78,200 | 78,600 | 43,200 | 6 |

TABLE 8
Gel Viscosity Test at 60 rpm Spindle Speed.
Greensboro Tap water was used as a test fluid

| | Viscosities [cP], Brookfield, 60 rpm | | | |
|---|---|---|---|---|
| Mixed % | Example 1 | Example 2 | Example 3 | Spindle No.: |
| 1.00 | 812 | 828 | 160 | 3 |
| 1.50 | 2,368 | 2,474 | 1,060 | 4 |
| 2.00 | 5,574 | 5,568 | 1,970 | 5 |
| 2.50 | 7,648 | 7,650 | 3,880 | 6 |
| 3.00 | 11,400 | 10,980 | 6,870 | 6 |

TABLE 9
Nominal Composition of the Tap Water
from the City Of Greensboro, NC

| | | Nominal | Average | |
|---|---|---|---|---|
| | | Range | Range | |
| Substance or | | from Routine | from Routine | Potential Source |
| Characteristic | Unit | Testing | Testing | of Substance |
| Aluminum | mg/L | <0.01-0.14 | 0.06 | Residual from the |
| | | | | treatment |
| | | | | process |
| Chloride | mg/L | 6.0-12.0 | 10.0 | Naturally |
| | | | | occurring in the |
| | | | | soil |
| Chlorine, Free | mg/L | 0.98-2.90 | 1.70-1.72 | Water additive |
| residual | | | | used to control |
| | | | | microbes |
| Fluoride | mg/L | 0.09-1.16 | 0.76-0.80 | Water additive |
| | | | | which promotes |
| | | | | strong teeth |
| Hardness, Total | mg/L | 31-47 | 37 | Natural deposits |
| | | | | and the treatment |
| | | | | process |
| Nitrate as | mg/L | 0.15-0.54 | 0.30 | Fertilizer runoff; |
| Nitrogen | | | | sewage; natural |
| | | | | deposits |
| pH | SU | 7.0-8.6 | 7.43-7.46 | |
| Phosphorus, | mg/L | 0.15-0.55 | 0.26 | Fertilizer runoff; |
| Total | | | | Corrosion control |
| | | | | treatment |
| Sodium | mg/L | 6.3-12.1 | 10.0 | Naturally |
| | | | | occurring |
| | | | | minerals in the |
| | | | | soil |
| Sulfate | mg/L | 19.1-48.4 | 28.0 | Naturally |
| | | | | occurring |
| | | | | minerals in the |
| | | | | soil |
| Total Dissolved | mg/L | 73-104 | 87 | Erosion of natural |
| Solids (TDS) | | | | deposits; |
| | | | | treatment |
| | | | | process |
| Total Organic | mg/L | 1.88-5.20 | 2.35-2.68 | Naturally present |
| Carbon³ | | | | in the |
| | | | | environment |

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by an aspect of an embodiment and/or embodiments of the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

While typical aspects of embodiment and/or embodiments have been set forth for the purpose of illustration, the foregoing description and the accompanying drawings should not be deemed to be a limitation on the scope of the invention. Accordingly, various modifications, adaptations, and alternatives may occur to one skilled in the art without departing from the spirit and scope of the present invention. By way of example, further additives can be added to further reduce the corrosion rates of the fire fighting additive and/or the fire fighting composition. Commercial corrosion inhibitors (e.g., the COBRATEC® family of corrosion inhibitors available from PMC Specialties Group, Inc. Cincinnati, Ohio, USA) can be used as well as alkali metal carbonates or alkali metal hydrocarbonates in a concentration range of about 0.1 wt % to about 3 wt %. Also, the viscosity of the fire fighting additive might be modified by additives to optimally suit the conditions of applications, for example at low temperatures and/or high temperatures.

It should be understood that all such modifications and improvements have been deleted herein for the sake of conciseness and readability but are properly within the scope of the following claims.

1. A fire protection and/or fire fighting additive comprising
(a) from about 10 wt % to about 70 wt % of acrylamide-free, crosslinked, and water-swellable polymer based prepare by inverse phase polymerization, based on the total weight of the additive;
(b) from about 10 wt % to about 80 wt % of a water immiscible phase, based on the total weight of the additive;
(c) from about 0.5 wt % to about 10 wt % of an emulsifier, based on the total weight of the additive;
(d) from about 0.5 wt % to about 10 wt % of an inverter, based on the total weight of the additive; and
(e) the remainder to 100 wt % of water, based on the total weight of the additive.

2. The fire protection and/or fire fighting additive of claim 1 having a corrosion rate for 2024-T3 aluminum of less than about 5 mils/yr.

3. The fire protection and/or fire fighting additive of claim 1 having corrosion rate for 4130 steel of less than about 5 mils/yr.

4. The fire protection and/or fire fighting additive of claim 1 having corrosion for yellow brass of less than about 5 mils/yr.

5. The fire protection and/or fire fighting additive of claim 1 having corrosion for AZ31B magnesium of less than about 5 mils/yr.

6. The fire protection and/or fire fighting additive of claim 1 wherein the inverter is not a nonylphenol ethoxylate.

7. The fire protection and/or fire fighting additive of claim 1 having a swelling time of not more than about 3 minutes.

8. The fire protection and/or fire fighting additive of claim 7 having a swelling time of not more than about 30 sec.

9. The fire protection and/or fire fighting additive of claim 1 wherein the crosslinked, water-swellable polymer includes from about 0.001 wt % to about 1 wt % of a chelator, based on the total weight of the additive.

10. A process for making an additive combinable with water for use in a fire protection and/or fire fighting composition, the additive having a continuous water immiscible phase and an acrylamide-free, crosslinked, and water-swellable polymer beads dispersed throughout the water immiscible phase, the process comprising the steps of:
(a) forming an aqueous solution of acrylamide-free, water-soluble, and ethylenically unsaturated monomer or acrylamide-free, water-soluble, and ethylenically unsaturated monomer blend, the aqueous solution comprising:
(i) an acrylamide-free, water-soluble, and ethylenically unsaturated monomer or an acrylamide-free, water-soluble, and ethylenically unsaturated monomer blend, wherein the monomer or monomer blend comprises from about 10 wt % to about 60 wt %, based on the total weight of the additive,
(ii) an ethylenically unsaturated water-soluble sulfonic acid monomer or an ethylenically unsaturated water-soluble sulfonic acid monomer blend, wherein the monomer or monomer blend comprises from 0.1 wt % to about 5 wt %, based on the total weight of the additive,
(iii) a neutralizer or a neutralizer blend, wherein the neutralizer or a neutralizer blend comprises at least about 25 mol %, based on the total of the monomer or monomer blend, and
(iv) a remainder to 100 wt % of water, based on the total weight of the additive;
(b) forming, in the presence of an emulsifier or emulsifier blend, wherein the emulsifier or emulsifier blend comprises from about 0.5 wt % to about 10 wt %, based on the total weight of the of the additive, aqueous monomer beads of the monomer solution of (a) in a water-immiscible phase comprising from about 10 wt % to about 80 wt %, based on the total weight of the of the additive;
(c) polymerizing the monomer solution of (a) in the presence of:
(i) an initiator or initiator blend, wherein the initiator or initiator blend comprises from about 0.1 wt % to about 5 wt % of a thermal initiator, based on the total weight of the additive, and
(ii) a crosslinker or crosslinker blend, wherein the crosslinker or crosslinker blend comprises about 0.01 wt % to about 2 wt %, based on the total weight of the additive,
to form polymer beads;
(d) adding to the polymerized product of (c):
(i) an inverter or inverter blend, wherein the inverter or inverter blend comprises from about 0.5 wt % to about 10 wt %, based on the total weight of the additive, and
(ii) a residual-monomer eliminator or residual-monomer eliminator blend, wherein the residual-monomer eliminator or residual-monomer eliminator blend comprises from about 0.1 wt % to about 2 wt %, based on the total weight of the additive,
wherein the additive does not include acrylamide.

11. The process of claim 10 wherein the additive has corrosion rate for 2024-T3 aluminum of less than about 5 mils/yr.

12. The process of claim 10 wherein the additive has corrosion rate for 2024-T3 aluminum of less than about 1 mil/yr.

13. The process of claim 10 wherein the additive has corrosion rate for 4130 steel of less than about 5 mils/yr.

14. The process of claim 10 wherein the additive has corrosion rate for 4130 steel of less than about 1 mil/yr.

15. The process of claim 10 wherein the additive has corrosion rate for yellow brass of less than about 5 mils/yr.

16. The process of claim 10 wherein the additive has corrosion rate for yellow brass of less than about 1 mil/yr.

17. The process of claim 10 wherein the additive has corrosion rate for AZ31B magnesium of less than about 5 mils/yr.

18. The process of claim 10 wherein the inverter is not a nonylphenol ethoxylate.

19. The process of claim 10 wherein the monomer solution includes from about 0.001 wt % to about 1 wt % of a chelator, based on the total weight of the additive.

20. A fire protection and/or fire fighting composition comprising
(a) from about 0.1 wt % to about 5 wt % of a fire protection and/or fire fighting additive, based on the total weight of the composition, the additive comprising:
(i) from about 10 wt % to about 70 wt % of acrylamide-free, crosslinked, and water-swellable polymer prepared by inverse phase polymerization, based on the total weight of the additive;
(ii) from about 10 wt % to about 80 wt % of a water-immiscible phase, based on the total weight of the additive;
(iii) from about 0.5 wt % to about 10 wt % of an emulsifier, based on the total weight of the additive;
(iv) from about 0.5 wt % to about 10 wt % of an inverter, based on the total weight of the additive; and
(v) the remainder to 100 wt % of water, based on the total weight of the additive, and
(b) from about 95 wt % to about 99.9 wt % of a fire-extinguishing agent, based on the total weight of the composition.

21. The fire protection and/or fire fighting composition of claim 20 having a viscosity of at least about 100 mPa·s.

22. The fire protection and/or fire fighting composition of claim 20 having a corrosion rate for 2024-T3 aluminum of less than about 2 mils/yr.

23. The fire protection and/or fire fighting composition of claim 20 having a corrosion rate for 4130 steel of less than about 5 mils/yr.

24. The fire protection and/or fire fighting composition of claim 20 having a corrosion rate for 4130 steel of less than about 1 mil/yr.

25. The fire protection and/or fire fighting composition of claim 20 having a corrosion rate for yellow brass of less than about 5 mils/yr.

26. The fire protection and/or fire fighting composition of claim 20 having a corrosion rate for yellow brass of less than about 1 mil/yr.

27. The fire protection and/or fire fighting composition of claim 20 having a corrosion rate for AZ31B magnesium of less than about 4 mils/yr.

28. The fire protection and/or fire fighting composition of claim 20 wherein the fire-extinguishing agent is water.

29. The fire protection and/or fire fighting composition of claim 20 wherein the fire protection and/or fire fighting additive further includes from about 0.001 wt % to about 1 wt % of a chelator, based on the total weight of the fire protection and/or fire fighting additive.

30. A method comprising a step of applying a sufficient amount of a fire protection and/or fire fighting composition to the combustible object to prevent, retard, suppress, or extinguish a fire, the fire protection and/or fire fighting composition comprising:
(a) from about 0.1 wt % to about 5 wt % of a fire protection and/or fire fighting additive, based on the total weight of the composition, that additive comprising:
(i) from about 10 wt % to about 70 wt % of acrylamide-free, crosslinked, and water-swellable polymer prepared by inverse phase polymerization, based on the total weight of the additive;
(ii) from about 10 wt % to about 80 wt % of a water-immiscible phase, based on the total weight of the additive;
(iii) from about 0.5 wt % to about 10 wt % of an emulsifier, based on the total weight of the additive;
(iv) from about 0.5 wt % to about 10 wt % of an inverter, based on the total weight of the additive; and
(v) the remainder to 100 wt % of water, based on the total weight of the additive, and
(b) from about 95 wt % to about 99.9 wt % of a fire-extinguishing agent, based on the total weight of the composition.

31. The process of claim 30 wherein the fire protection and/or fire fighting composition has a viscosity of at least about 100 mPa·s.

32. The process of claim 30 wherein the fire protection and/or fire fighting composition has a corrosion rate for 2024-T3 aluminum of less than about 5 mils/yr.

33. The process of claim 30 wherein the fire protection and/or fire fighting composition has a corrosion rate for 2024-T3 aluminum of less than about 1 mil/yr.

34. The process of claim 30 wherein the fire protection and/or fire fighting composition has a corrosion rate for 4130 steel of less than about 5 mils/yr.

35. The process of claim 30 wherein the fire protection and/or fire fighting composition has a corrosion rate for 4130 steel of less than about 1 mil/yr.

36. The process of claim 30 wherein the fire protection and/or fire fighting composition has a corrosion rate for yellow brass of less than about 5 mils/yr.

37. The process of claim 30 wherein the fire protection and/or fire fighting composition has a corrosion rate for yellow brass of less than about 1 mil/yr.

38. The process of claim 30 wherein the fire protection and/or fire fighting composition has a corrosion rate for AZ31B magnesium of less than about 4 mils/yr.

39. The process of claim 30 wherein the fire-extinguishing agent comprises water.

40. The process of claim 30 wherein the fire protection and/or fire fighting additive further includes from about 0.001 wt % to about 1 wt % of a chelator, based on the total weight of the polymer dispersion.

41. A device for the prevention and/or fighting of fires comprising a pressure-resistant container in which:
(a) a fire protection and/or fire fighting additive and fire-extinguishing agent are present and separated from one another, the fire protection and/or fire fighting additive comprising:
(i) from about 10 wt % to about 70 wt % of acrylamide-free, crosslinked, and water-swellable polymer prepared by inverse phase polymerization, based on the total weight of the additive, (ii) from about 10 wt % to about 80 wt % of a water-immiscible phase, based on the total weight of the additive,
(iii) from about 0.5 wt % to about 10 wt % of an emulsifier, based on the total weight of the additive,
(iv) from about 0.5 wt % to about 10 wt % of an inverter, based on the total weight of the additive, and
(v) the remainder to 100 wt % of water, based on the total weight of the additive; or
(b) a fire protection and/or fire fighting additive and fire-extinguishing agent are present and combined with one another as a fire protection and/or fire fighting composition comprising:
(i) from about 0.1 wt % to about 5 wt % of a fire protection and/or fire fighting additive, based on the total weight of the composition, the additive comprising:
(1) from about 10 wt % to about 70 wt % of acrylamide-free, crosslinked, and water-swellable polymer prepared by inverse phase polymerization, based on the total weight of the additive,
(2) from about 10 wt % to about 80 wt % of a water-immiscible phase, based on the total weight of the additive,
(3) from about 0.5 wt % to about 10 wt % of an emulsifier, based on the total weight of the additive,
(4) from about 0.5 wt % to about 10 wt % of an inverter, based on the total weight of the additive, and
(5) the remainder to 100 wt % of water, based on the total weight of the additive, and
(ii) from about 95 wt % to about 99.9 wt % of a fire-extinguishing agent, based on the total weight of the composition.

42. A device according to claim 41 wherein the device is a manual fire-extinguisher or a fire-extinguisher train.
